(19) United States
(12) Patent Application Publication
(10) Pub. No.: US 2011/0110792 A1
(43) Pub. Date: May 12, 2011

(54) SENSORS AND METHODS AND APPARATUS RELATING TO SAME

(76) Inventors: Joseph Kendall Mauro, Cincinnati, OH (US); Philip Anthony Mayleben, Edgewood, KY (US); Michael Patrick Dyer, Oxford, OH (US); Thomas R. Stetter, Cincinnati, OH (US)

(21) Appl. No.: 12/617,377

(22) Filed: Nov. 12, 2009

(51) Int. Cl. F04B 49/06; G01F 23/26

(52) U.S. Cl. 417/44.1; 73/304 C

(57) ABSTRACT

In one form a capacitive sensor is disclosed for immersion into a fluid, the capacitive sensor having a housing and first and second electrodes with the first electrode being disposed at least partially within the housing and electrically connected to a circuit, the second electrode being electrically connected to the circuit via an electrical connection and physically separated from the housing containing at least a portion of the first electrode so that at least a portion of the electrical connection or second electrode is located above or outside of the fluid to reduce the risk that minerals will form between the electrodes. In other forms, capacitors, capacitive sensors, pump controls and systems utilizing these features are disclosed along with methods and apparatus relating to same. In yet other forms additional sensors such as current sensors, thermal sensors, speed sensors, torque sensors and Hall Effect sensors are disclosed for use alone or in combination with said capacitive sensor for detecting fluid level and/or controlling pumps.

### FIELD OF THE INVENTION

The present invention relates to sensors and methods and apparatus relating to same.

### BACKGROUND OF THE INVENTION

Sensors are needed for a variety of applications. For example, pump applications, such as sump, dewatering, sewage, utility, effluent and grinder pumps, can use sensors to determine when the pump should be turned on and/or turned off. Conventional sump pumps generally include a pump having a mechanical switch connected to a float mechanism for controlling a liquid level in a reservoir. The float mechanism is disposed within the reservoir and adapted to travel on the surface of the liquid as the liquid rises and falls. Typical float mechanisms are mechanically connected to the switch and according to the position of the float relative to the pump, the switch controls power to the pump.

In one configuration, the mechanical connection between the switch and the float includes a flexible tether. As the float travels up or down on the surface of the liquid in the reservoir, the orientation of the flexible tether relative to the switch changes. Another typical form of a float mechanism includes one or more rods or interconnected linkages. Similar to the tether, the rods or linkages are configured to allow the float to travel freely with the rising or falling of the surface of the liquid in the reservoir. In either of these configurations, once the float reaches a predetermined upper limit, the tether, rod, or linkage transfers a mechanical force to flip the switch, thereby completing the circuit and activating the pump. Conversely, when the liquid level and the float reach a predetermined lower limit, the tether, rod, or linkage transfers a mechanical force to the switch in an opposite direction, thereby interrupting the circuit and deactivating the pump.

A shortcoming of the above-described sump pump float switch mechanisms is that they are inclined to experience mechanical failure. Sometimes mechanical failure occurs due to a deterioration of the mechanical connection between the float and the switch. Other times, the mechanical failure may occur due to objects in the reservoir that restrict or hinder the proper operation of the float mechanism.

A further known sump pump switching mechanism includes a resistance switching mechanism. Resistance switching mechanisms include a pair of electrodes exposed in the liquid in the reservoir. As the level of the liquid in the reservoir changes relative to the electrodes, the electrical resistance between the two electrodes changes. Based on the change in resistance between the two electrodes, a controller activates or deactivates the pump. A shortcoming of resistance type switch mechanisms is that the electrodes are exposed to the liquid and tend to be vulnerable to corrosion. Once corroded, the electrodes fail to generate accurate resistances that the controller expects and the controller fails to operate properly.

A still further known sump pump switching mechanism includes a capacitance switching mechanism. Capacitance switching mechanisms generally include a controller, an upper capacitor having two electrodes, and a lower capacitor having two electrodes. The upper and lower capacitors operate substantially independent of each other. When the level of the liquid reaches the upper capacitor, the controller detects a capacitance across both capacitors and activates the pump. The controller continues to activate the pump as the level of the liquid in the reservoir drops. Once the level of the liquid drops below the lower capacitor, the controller detects no capacitance across the lower capacitor and deactivates the pump. One shortcoming of such capacitance-based switching mechanisms is the reliance on multiple capacitors. Failure of one of the upper and lower capacitors may detrimentally affect the proper operation of the entire sump pump.

In other known sump pump applications, magnetic switching mechanisms, such as Hall Effect sensors or switches, are used to detect water levels and operate a pump. For example, in some applications, a float is used to raise a magnet to an upper magnetic sensor at which point the pump is turned on. When the water level drops the float descends down to a lower magnetic sensor at which point the pump is turned off. A shortcoming of such magnetic sensors is that they again require moving parts and are inclined to experience mechanical failure, such as that discussed above with respect to tethers.

Accordingly, it has been determined that a need exists for an improved sensor and method and apparatus for controlling a pump using same which overcome the aforementioned limitations and which further provide capabilities, features and functions, not available in current sensors and pumps.

### SUMMARY OF THE INVENTION

In one form the present invention provides a variable capacitor having first and second electrodes and a dielectric connecting the first and second electrodes to form a capacitor having a readable capacitance. The dielectric includes a first part made of an insulative material and a second part made of a liquid that changes levels with respect to the insulative material which causes a change in the capacitance of the capacitor. Thus, the changing liquid level with respect to the insulative material provides a variable capacitor capable of producing a plurality of different capacitances.

In another form, the invention provides a capacitive sensor having a capacitor at least partially immersed in a liquid having a level that changes in relation to the capacitor, with the capacitor having a variable capacitance depending on the level of the liquid for providing a capacitance reading associated with the liquid level as mentioned above, and a circuit connected to the capacitor to determine the capacitance of the capacitor. Thus, the level of the liquid within which the capacitor is immersed may be determined based on the capacitance of the capacitor and the sensor may be used with a number of different pieces of equipment that are to be operated in response to changing liquid levels.

For example, one aspect of the present invention provides a pump controller for controlling the level of a liquid in a reservoir. The pump controller includes a controller and a capacitor. The capacitor is adapted to provide a first capacitance to the controller when the liquid in the reservoir reaches a first predetermined level relative thereto. Additionally, the capacitor is adapted to provide a second capacitance to the controller when the liquid in the reservoir reaches a second level relative thereto. Based on the second capacitance, the controller determines when to deactivate the pump.

One advantage of this form of the present invention is that it requires no moving parts that may suffer mechanical failure. The apparatus serves as a solid state sensor that detects liquid level to control activation and deactivation of the pump. Another advantage of this form of the present invention is that the capacitor may be wholly contained within the pump controller. Thus, the electrodes of the capacitor do not have to be exposed to the liquid in the reservoir and, therefore, would not be vulnerable to corrosion such as the electrodes in prior known resistance-based devices. A further advantage of this pump controller is that it includes a single capacitor in communication with the controller. This overall design reduces the number of electrical, mechanical, or electro-mechanical components that may suffer failure, makes it easier to assemble the sensor and can reduce cost associated with assembly and/or material costs for the apparatus.

In another form, the controller determines a run-time based on the second capacitance detected by the controller for which the pump should be activated to move a predetermined amount of the liquid out of the reservoir. For example, the controller may determine the flow rate of the liquid out of the reservoir based on the difference in capacitance readings from the time the pump was activated (e.g., the first capacitance reading) to the time the second capacitance reading was taken and calculate how much longer the pump needs to remain operating at that flow rate in order to lower the liquid level in the reservoir to a desired level.

In another form, the controller may be configured to deactivate the pump upon detecting the second capacitance from the capacitor. For example, the controller may be setup to regularly, or even continually, monitor the capacitance reading from the capacitor and shut off the pump once a predetermined capacitance value has been reached because the predetermined capacitance value is indicative of the fact the liquid level in the reservoir has dropped to a desired level. In one form, the apparatus includes a power source generating an alternating current and the controller is configured to detect the capacitance of the capacitor (or data associated with same) each time the alternating current is at a zero-crossing. In another form, the apparatus continually monitors the capacitance reading from the capacitor (or data associated with same).

In yet other forms of the invention, a variable capacitor, capacitive sensor and/or pump control is/are provided having an external electrode or probe for detecting capacitance in environments having highly conductive fluids or fluids with highly conductive minerals therein, such as for example sewage applications or other pump applications where conductive materials such as minerals can form between the capacitor electrodes. The remote positioning of the electrode or probe reduces the likelihood that conductive particles will collect between the terminals and thereby affect the ability of the capacitor, sensor and/or pump control to accurately measure capacitance based on the level of fluid making up at least a portion of the dielectric. Methods relating to the operation and use of such capacitors, sensors and pump controls are also disclosed herein.

In another form a first type of sensor, such as a capacitive sensor, is used to trigger operation of a device, such as a pump, and a second different type of sensor, such as a current sensor, thermal sensor, speed/torque sensor or Hall Effect sensor, is used to either shut off the device or determine how long to operate the device. For example, in one form, a pump system is disclosed in which a capacitive sensor is used to turn on a pump to evacuate a fluid from an area and a current sensor is used to determine when to shut the pump off. Methods relating to the operation and use of such a two-sensor system are also disclosed herein.

### BRIEF DESCRIPTION OF THE DRAWINGS

The invention will be explained in exemplary embodiments with reference to drawings, in which:

FIG. 1 is a side view of a first embodiment of a sump pump system disposed within a reservoir and incorporating a sensor unit in accordance with one form of the present invention;

FIG. 2 is a side cross-sectional view of the sensor unit of the first embodiment of the sensor unit depicted in FIG. 1;

FIG. 3 is a block diagram of the pump control of FIG. 1;

FIG. 4A is a detailed schematic diagram of a pump control circuit using the sensor unit depicted in FIGS. 1-3;

FIG. 4B is an enlarged schematic cross-sectional view of a the capacitor of the control circuit of FIG. 4A;

FIG. 5 is a flowchart of a general operation process of the sensor unit depicted in FIGS. 1-3;

FIG. 6 is a flowchart of a process of controlling a level of a liquid in a reservoir in accordance with one form of the present invention;

FIG. 7 is a flowchart of a process of controlling a level of a liquid in a reservoir in accordance with another form of the present invention;

FIG. 8 is a side view of an alternate embodiment of a sump pump disposed within a reservoir and incorporating an integrated sensor unit according to the principles of the present invention;

FIG. 9 is a perspective view of an alternate embodiment of a sump pump incorporating an integrated sensor unit in accordance with the present invention, with a portion of the outer housing shown in transparent to illustrate the internal components therein;

FIG. 10 is a top cross-sectional view of the embodiment of FIG. 9;

FIG. 11 is a top cross-sectional view of an alternate embodiment of the sump pump of FIG. 9 with the integrated sensor unit mounted in a slot of the pump housing;

FIG. 12 is an alternate embodiment of a sensor unit in accordance with the invention, showing the sensor unit connected to a discharge pipe rather than the pump housing;

FIG. 13 is a perspective view of yet another embodiment of the pump sensor and configuration for the pump and pump sensor in accordance with the invention;

FIGS. 14A, 14B, and 14C are perspective, front and rear elevational views of the sensor illustrated in FIG. 13;

FIG. 14D is a cross-sectional view of the sensor of FIGS. 14A-14C taken along line 14D-14D of FIG. 14B;

FIGS. 15A-15C are top, front and rear elevational views of a piggyback switch cord in accordance with the invention;

FIG. 15D is a wiring schematic for the piggyback switch cord of FIGS. 15A-15C;

FIG. 16 is an enlarged perspective view of a sensor circuit board in accordance with the invention illustrating a heat sink connected to the circuit board via a circuit component;

FIG. 17 is a perspective view of a dual pump system with a primary pump system incorporating a sensor unit in accordance with the invention and a battery-powered back-up pump system; the dual pump system includes a wireless or wired alert system including a receiver for informing the user of the status of the system;

FIG. 18 is a perspective view of another embodiment of the pump sensor illustrated in FIGS. 13-14D and elsewhere herein, in which one of the terminals or probes of the capacitor is located remotely from the other terminal or probe so as to reduce the likelihood of conductive material buildup between the terminals;

FIGS. 19A-B are front and rear exploded views of the pump sensor of FIG. 18 further illustrating location and potion of the probes of the capacitor;

FIG. 20 is a detailed schematic diagram of a pump control circuit using the sensor unit depicted in FIGS. 18-19B; and

FIG. 21 is a block diagram of another sensor and pump control system in accordance with the invention in which a first type of sensor is used to determine when a pump device should be turned on and a second/different type of sensor is used to determine when the pump device should be turned off.

### DETAILED DESCRIPTION OF THE PREFERRED EMBODIMENT

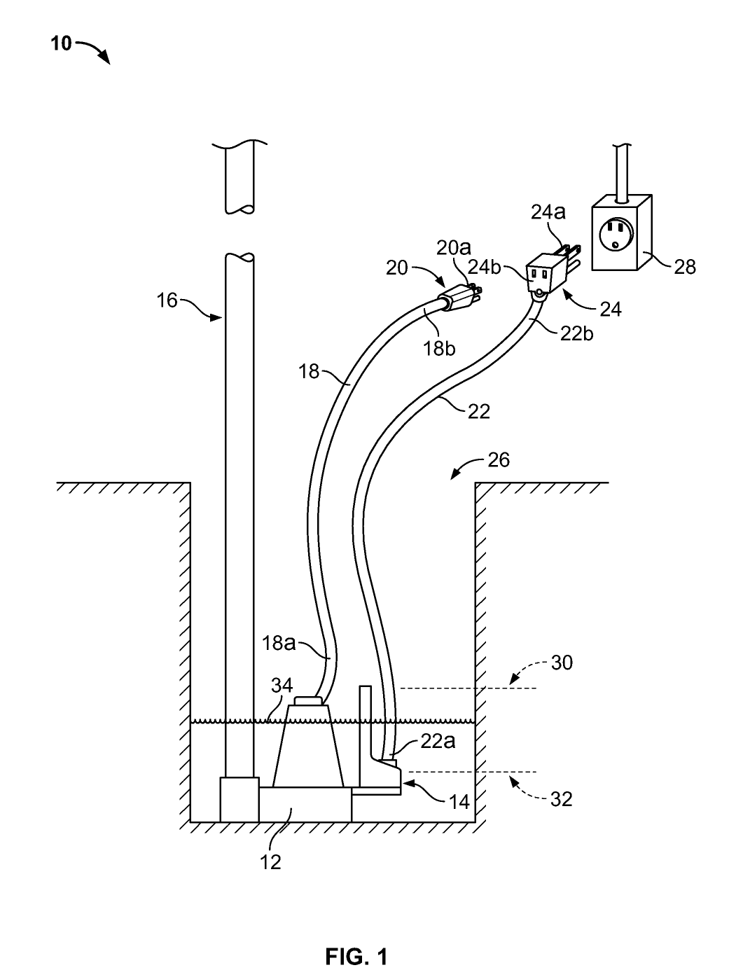

FIG. 1 depicts a sump pump system 10 disposed within a reservoir 26. The sump pump system 10 includes a pump 12, a sensor or sensor unit 14, and a discharge pipe 16. In general, the sensor unit 14 monitors the level of a liquid 34 within the reservoir 26 and serves as a switch for activating and deactivating the pump 12 based on that level. When the level of the liquid 34 reaches a predetermined upper limit, which is identified by reference numeral 30 in FIG. 1, the sensor unit 14 activates the pump 12. Upon activation, the pump 12 begins moving the liquid 34 up and out of the reservoir 26 via the discharge pipe 16. This begins to lower the level of the liquid 34 in the reservoir 26. Once the level of the liquid 34 reaches a predetermined lower limit, which is identified by reference numeral 32 in FIG. 1, the sensor unit 14 deactivates the pump 12. The details of the sump pump system 10 will now be discussed in more detail with continued reference to the figures.

FIG. 1 depicts the sensor unit 14 including a power cord, such as piggy-back cord 22, having an originating end 22a fixed to the sensor unit 14 and a terminal end 22b connected to a plug 24. The piggy-back plug 24 has a standard three-prong male connector 24a and a standard three-point female receptacle 24b. The pump 12 includes a power cord 18 having an originating end 18a fixed to the pump 12 and a terminal end 18b connected to a plug 20. The plug 20 has a standard three-prong male connector 20a. Upon installation, the male connector 24a of the piggy-back plug 24 of the sensor unit 14 is disposed within a standard 115VAC-230VAC electrical outlet, which is identified by reference numeral 28 in FIG. 1. Additionally, the male connector 20a of the plug 20 of the pump 12 is disposed within the female receptacle 24b of the piggy-back plug 24 of the sensor unit 14. Thus, the electrical outlet 28, the sensor unit 14, and the pump 12 are electrically connected in series with one another. So configured, electrical current provided by the electrical outlet 28 will only power the pump 12 when the sensor unit 14 operates as a closed switch, completing the circuit and enabling current to pass therethrough. Additionally, this configuration enables the sensor unit 14 and the pump 12 to be constructed independent of each other. An advantage of this independence is that the pump 12 and/or the sensor unit 14 may be replaced or purchased independently of the other. Meaning, the sensor unit 14 could be adapted to operate with nearly any available pump so long as the plugs are interconnectable.

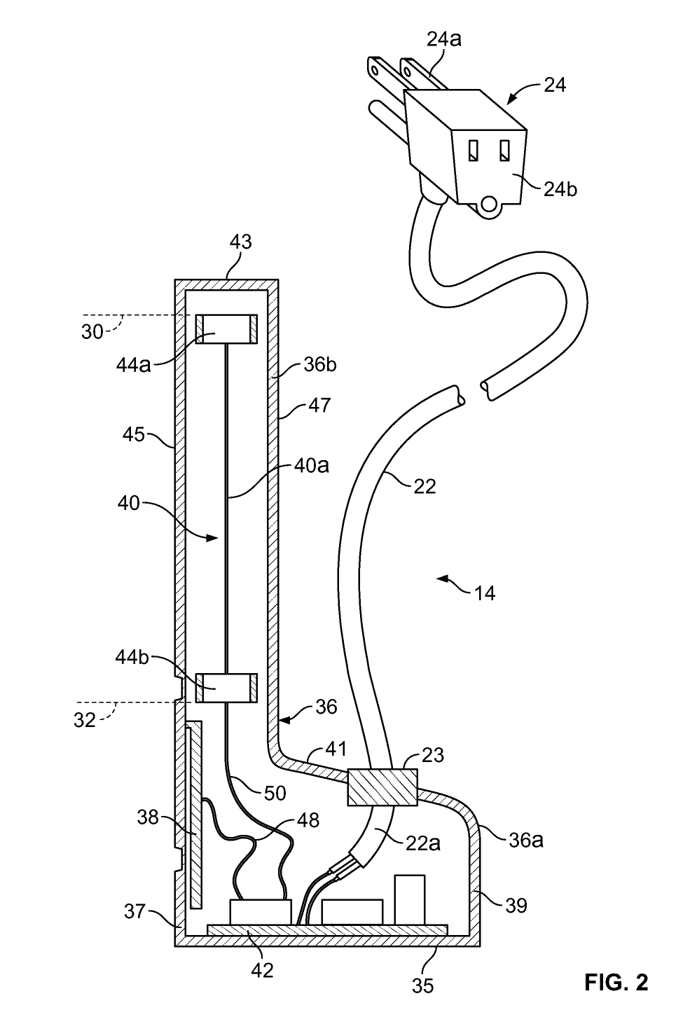

FIG. 2 depicts a more detailed view of the sensor unit 14 of the sump pump system 10 depicted in FIG. 1. As stated above, the sensor unit 14 includes a power cord 22 terminating in a piggy-back plug 24. Additionally, as depicted in FIG. 2, the sensor unit 14 includes a housing 36, a reference electrode 38, a detection electrode 40, and a circuit board 42. In the form illustrated, the housing 36 is a hollow, generally L-shaped box including a base portion 36a and an upper portion 36b extending generally perpendicularly from the base portion 36a. The base portion 36a is box-shaped and has a generally square side cross-section defined by a bottom wall 35, a first side wall 37, a second side wall 39, and a top wall 41. Additionally, the base portion 36a includes an opening in the top wall 41 receiving the originating end 22a of the power cord 22, which is electrically connected to the circuit located on circuit board 42, and preferably a strain relief 23. The upper portion 36b of the housing 36 is also box-shaped and has a generally elongated rectangular side cross-section defined by a top wall 43, a first side wall 45, and a second side wall 47.

The detection electrode 40 is disposed wholly within the upper portion 36b of the housing 36 and is situated directly above the reference electrode 38. A lower portion of the reference electrode 38 is disposed within the base portion 36a of the housing 36 and an upper portion of the reference electrode 38 is disposed within the upper portion 36b of the housing 36. The reference and detection electrodes 38, 40 each include a conductor, such as a metal plate. More specifically, in the embodiment illustrated, the detection electrode 40 includes a thin metal plate 40a having upper and lower biased portions 44a, 44b. In the form illustrated, the upper and lower biased portions 44a, 44b include metallic foil rings. The foil rings 44a, 44b enable the detection electrode 40 to provide a non-linear output across its length. For example, capacitance generated between the electrodes 38, 40 is larger when the level of the liquid 34 in the reservoir 26 is near one of the foil rings 44a, 44b than when it is near the center of the detection electrode 40. Additionally, the reference and detection electrodes 38, 40 are electrically connected to the circuit on the circuit board 40 with wires 48 and 50, respectively.

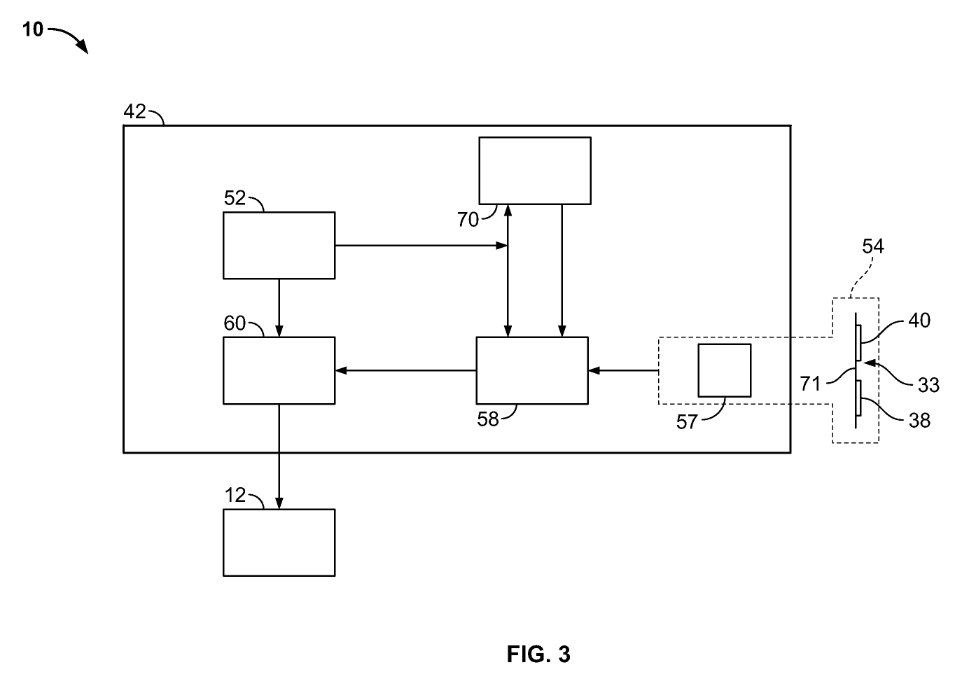

With reference to the block diagram provided in FIG. 3, the sump pump system 10 and, more particularly, the circuit board 42 includes a power supply 52, a capacitive sensor 54, a controller, such as microprocessor 58, an AC switch, such as solid state relay (SSR) 60, and signaling circuitry 70. The microprocessor 58 detects capacitance from the capacitive sensor 54 upon receipt of a signal delivered by the signaling circuitry 70, as will be described in more detail below. The microprocessor 58 then activates the pump 12 via the SSR 60 when the capacitance detected by the capacitive sensor 54 indicates that the liquid 34 in the reservoir 26 has reached the predetermined upper limit 30, as identified in FIGS. 1 and 2.

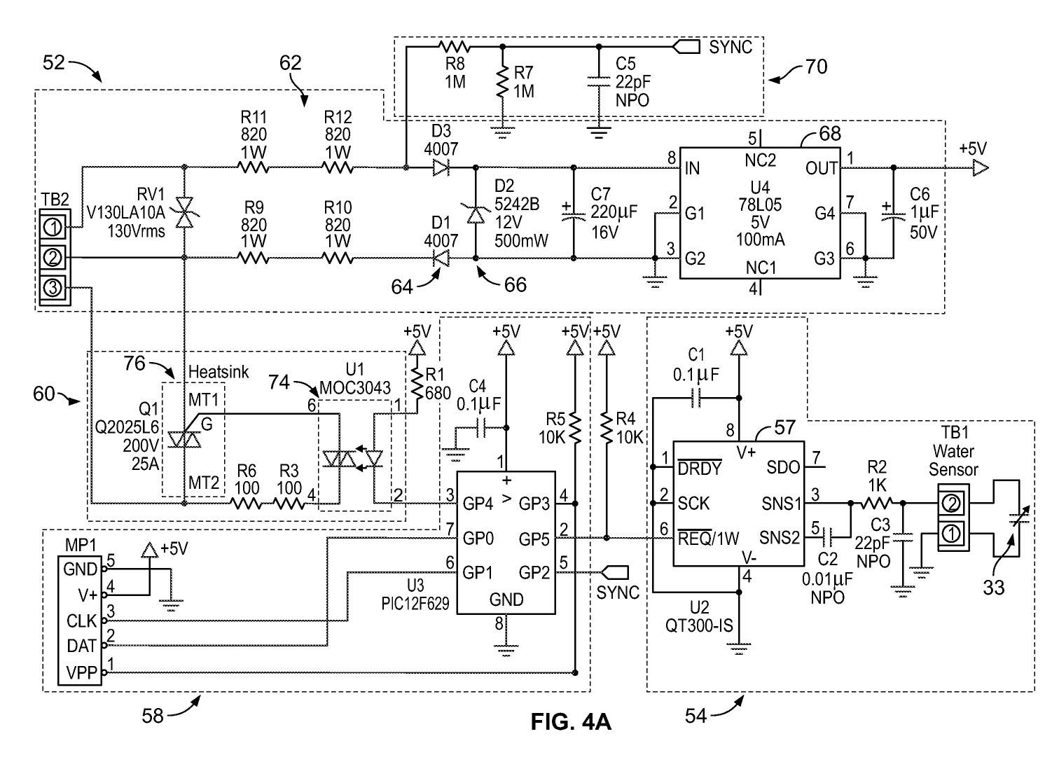

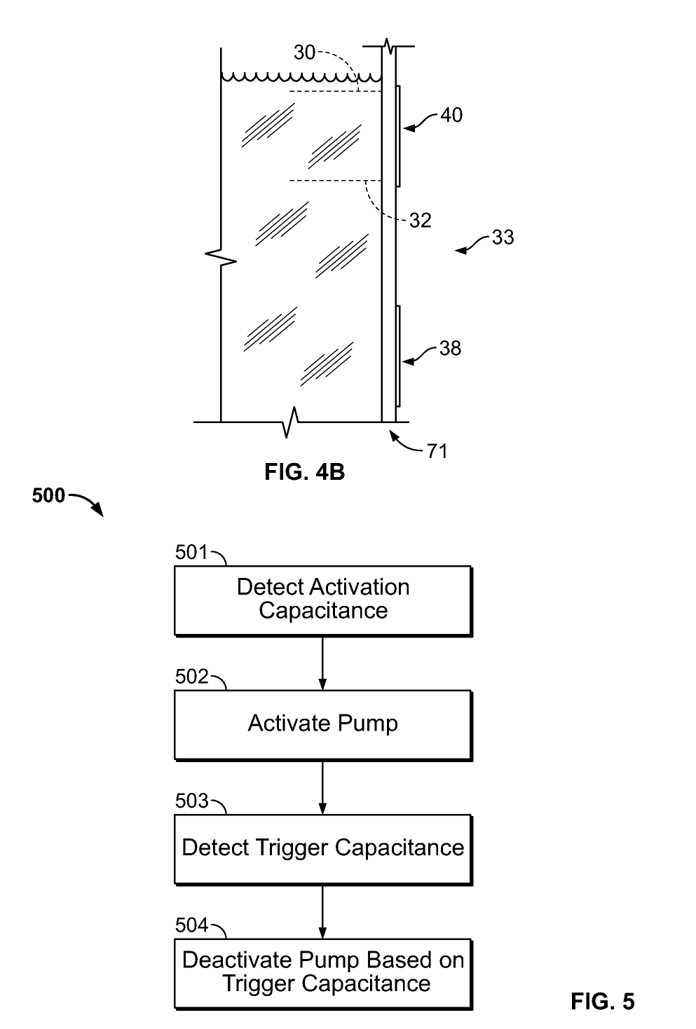

Referring now to FIGS. 3 and 4A-4B, the pump control circuit on circuit board 42 will be described in more detail. In the form illustrated, the pump control includes a power supply 52, a capacitive sensor 54, including a capacitor 33 and a capacitive sensing integrated circuit (IC) 57, a controller 58 and an AC switch 60 for actuating the pump (not shown). The power supply 52 includes an AC power source or input (e.g., 115-230VAC) (not shown), a voltage divider 62, a rectifier 64, a zener diode 66, a capacitor C7, and a voltage regulator 68. The voltage divider 62 includes a plurality of resistors R9, R10, R11 and R68 and the rectifier 64 includes two diodes D1 and D3. Together, the voltage divider 62, the rectifier 64 and the zener diode 66 step the AC voltage down to a rough or pulsating DC voltage, which in turn is filtered or smoothed out by the capacitor C7 and the voltage regulator 68 to generate a 5VDC output. This 5VDC output is supplied to various components of the circuit including, among other items, the capacitive sensor 54 and the microprocessor 58.

The signaling circuitry 70 comprises a line brought off of the AC input to the microprocessor (pin 5) through a current limiting resistor R8 to tell the processor when the input voltage signal is low enough to back bias the rectifier diodes. This tells the microprocessor to take a measurement reading from the capacitive sensor IC when there is a high impedance between the power line and reading circuitry, which minimizes the effects of stray capacitance tied to the two sensor plates 38 and 40 isolated by the dielectric layer 71. Thus, when the signaling circuitry 70 monitors the voltage from the power supply 52 and informs the microprocessor 58 when a zero-crossing of the voltage input signal occurs, the input voltage signal is low enough to back bias the diodes D1 and D3 of the rectifier 64 so that the microprocessor 58 can take an accurate reading from the capacitor 33.

The capacitor 33 includes the reference electrode 38, the detection electrode 40, a dielectric wall 71, and a capacitive sensing integrated circuit (IC), such as capacitance-to-digital converter 57, which is connected to the capacitor 33 so that the controller 58 can read and process the capacitance of capacitor 33 at the zero-crossings of the AC supply. It should be understood, however, that in alternate embodiments, a controller may be selected which can read and process data directly from the capacitor 33, if desired.

With reference to FIG. 4A, the dielectric wall 70 includes the first side wall 45 of the housing 36 of the sensor unit 14, as described above with reference to FIG. 2. The dielectric wall 70 serves to isolate the reference and detection electrodes 38, 40 from the liquid 34 in the reservoir 26, thereby creating capacitor 33. In a preferred form, the electrodes 38, 40 are positioned flush against the dielectric as illustrated in FIG. 4B so as to avoid air gaps between the dielectric and the electrodes 38, 40. In this form, the electrodes may be attached to the dielectric with epoxy so no air gaps will exist between the capacitor electrodes and the dielectric, which would otherwise negatively affect the performance of the capacitive sensor. In another form, the electrodes 38, 40 are encased in the insulative material of the dielectric, which also would eliminate air gaps between the electrodes and the dielectric. The reference electrode 38 is electrically connected to circuit ground and the detection electrode 40 is electrically connected to the capacitive sensing IC 57, as depicted schematically in FIG. 4A. The level of the liquid 34 in the reservoir 26 alters the performance of the side wall 45 and ultimately the value of capacitance generated by the capacitor 33. Thus, in this way, the dielectric is made up in part by the side wall 45 and in part by the liquid 34 so that the capacitance of capacitor 33 varies in relation to the liquid level of liquid 34.

In the form illustrated in FIG. 2, the side wall 45 is made of a polymer, such as plastic, and the housing 36 is filled with a protective material, such as a potting compound, to protect the capacitor 33 and other electronic circuit components from exposure to the liquid within which the capacitor 33 is immersed. The housing is first partially filled with the potting compound before the circuit board is inserted. Then, after the circuit board is inserted, the housing is filled with additional potting compound to fully protect the circuit components. The potting compound used to fill the housing after the circuit board is inserted may be the same potting compound as the first, or it may be of a different composition. For example, a second, different potting compound may be used for certain applications, such as sewage applications, where external conditions dictate the use of different materials. A small piece of foam may be used to hold the circuit board against the inside wall of the housing while the potting compound cures. This method has also been found effective to keep air from being trapped between the electrodes 38, 40 and the dielectric. However, as mentioned above, in a preferred form the electrodes 38, 40 are either epoxied to the dielectric wall 45 or encased in the dielectric wall to eliminate air gaps. In this form, the capacitance generated by the reference and detection electrodes 38, 40 varies from approximately 1 picofarad (pF) with the level of the liquid 34 in the reservoir 26 being located at the predetermined lower limit 32 of the detection electrode 40 to approximately 11 pF at the predetermined upper limit 30 of the detection electrode 40. As will be discussed more thoroughly below, the microprocessor 58 reads the capacitance generated by the reference and detection electrodes 38, 40 from the capacitive sensing IC 57. When the capacitance indicates that the level of the liquid 34 has reached the predetermined upper limit 30, the microprocessor 58 actuates the AC switch or SSR 60, which activates the pump 12.

The SSR 60 includes an opto-triac 74 and an AC solid state switch, such as a triac 76, or an alternistor. The switch 76 is electrically connected between the AC power supply 52 and the pump 12, and the opto-triac 74 is electrically connected between switch 76 and the microprocessor 58. The opto-triac 74 provides a zero voltage switch for triggering the switch 76 and, in the form illustrated, the switch 76 performs substantially the same function as two thyristors such as silicon controlled rectifiers (SCRs) wired in inverse parallel (or back-to-back). Thus, the opto-triac 74 drives the switch 76 and isolates or protects the microprocessor 58 and the other digital circuitry from the non-rectified AC signal that passes through the switch 76 when the pump 12 is activated. Additionally, the switch 76 allows both the positive and negative portions of the AC signal to be passed through to operate the pump 12.

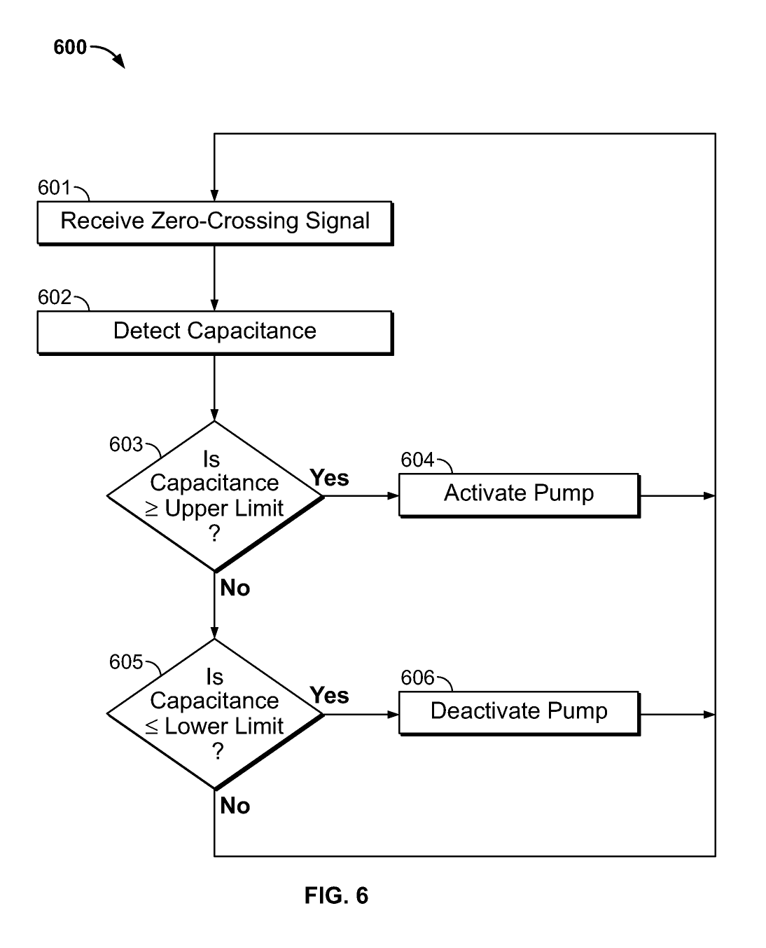

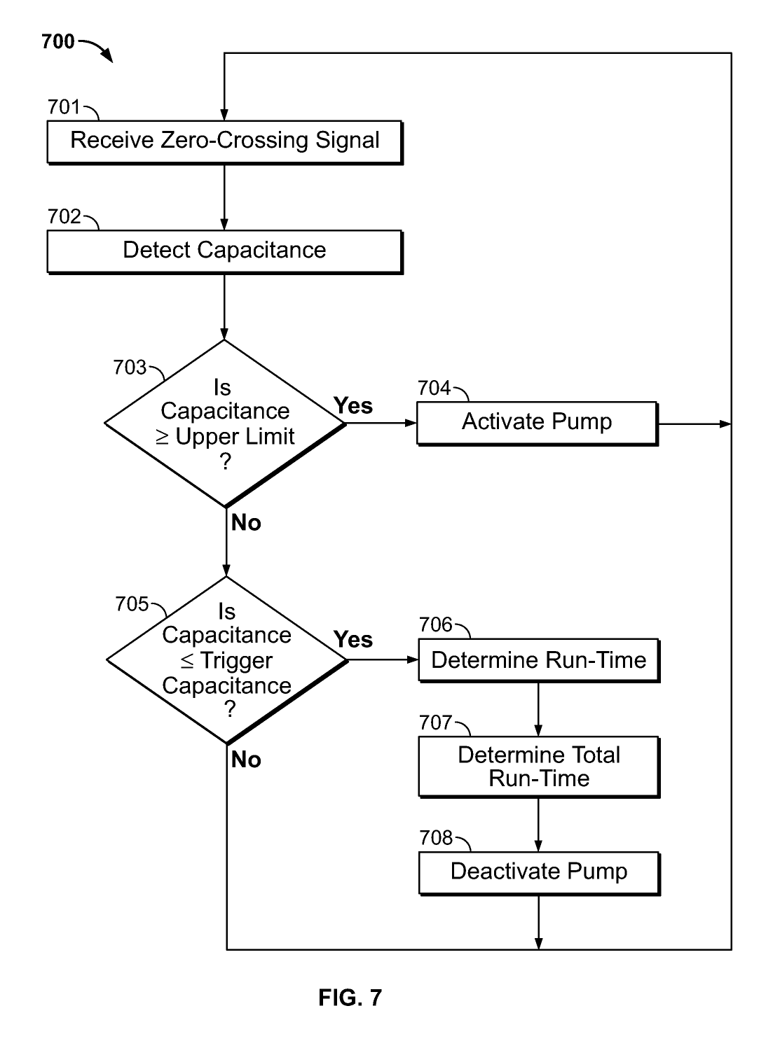

FIG. 5 depicts a flowchart of a general operational process performed by the microprocessor 58 of the sump pump system 10. First, when the level of the liquid 34 in the reservoir 26 reaches the predetermined upper limit 30, the microprocessor 58 detects the existence of an activation capacitance (e.g., equal to or above a predetermined capacitance) from the capacitor 33 of the sensor unit 14 at block 501. The microprocessor 58 then activates the pump 12 at block 502 to begin moving the liquid 34 out of the reservoir 26. Meanwhile, the microprocessor 58 continues detecting the capacitance generated by capacitor 33. Once the level of the liquid in the reservoir 26 falls to the lower limit 32 shown in FIGS. 1 and 2, the microprocessor 58 will detect the existence of a sample or trigger capacitance (which may be equal to or below a predetermined capacitance or alternatively a random capacitance) from the capacitor 33 at block 503, resulting in the microprocessor 58 deactivating the pump 12 at block 504. For example, in one form, the trigger capacitance is a predetermined value of capacitance and the microprocessor 58 simply deactivates the pump 12 when the trigger capacitance was detected. In another form, however, the trigger capacitance is either a predetermined capacitance value or a random capacitance value that simply allows the microprocessor 58 to calculate the flow rate of the liquid 34 evacuating the reservoir 26 so that the microprocessor 58 can determine how long the pump 12 should remain operating. This process will be discussed in greater detail below with reference to the various embodiments described with reference to FIGS. 6 and 7.

FIG. 6 depicts a detailed flowchart of a process 600 performed by the microprocessor 58 for activating and deactivating the pump 12 according to the present invention. The process 600 controls the level of the liquid 34 in the reservoir 26 by utilizing a sump pump system 10 such as that described above. First, the microprocessor 58 receives a zero-crossing signal from the signaling circuitry 70 at block 601. Substantially immediately thereafter, the microprocessor 58 detects a capacitance generated by the capacitor 33 at block 602. Specifically, in the form of the sump pump system 10 discussed above, the capacitance is generated between the reference and detection electrodes 38, 40 of the capacitor 33 and detected and translated to digital data by the capacitance-to-DC converter 57 so that the microprocessor 58 can process the digital data and determine whether to activate or deactivate the pump 12.

After the microprocessor 58 detects the capacitance, it determines whether the detected capacitance is equal to a predetermined upper limit capacitance at block 603. The predetermined upper limit capacitance corresponds to a capacitance generated by the electrodes 38, 40 when the level of the liquid 34 in the reservoir 26 is at the predetermined upper limit 30 shown in FIGS. 1 and 2. In the event the detected capacitance is equal to the upper limit capacitance, the microprocessor 58 activates the pump 12 at block 604 to move the liquid 34 out of the reservoir 26 via the discharge pipe 16. Specifically, in the form of the sump pump system 10 discussed above, the microprocessor 58 triggers or turns on the opto-triac 74 and the opto-triac 74 triggers or turns on the switch 76. This closes the circuit between the AC power supply and the pump 12 allowing the alternating current to travel directly to the pump 12 to operate the pump 12. Once the microprocessor 58 activates the pump 12, it waits to receive another zero-crossing signal from the signaling circuitry 70 at block 601 and repeats the process 600 accordingly.

Alternatively, if the microprocessor 58 determines at block 603 that the capacitance detected at block 602 is not equal to the predetermined upper limit capacitance, the micro-processor 58 determines whether the detected capacitance is less than or equal to a trigger capacitance at block 605. In this form of the process 600, the trigger capacitance is equal to a predetermined lower limit capacitance, which corresponds to a capacitance generated by the electrodes 38, 40 when the level of the liquid in the reservoir 26 is at the predetermined lower limit 32 shown in FIGS. 1 and 2. If the detected capacitance is greater than the lower limit capacitance, the microprocessor 58 returns to receiving zero-crossing signals from the signaling circuitry 70 at block 601. Alternatively, however, if the detected capacitance is less than or equal to the lower limit capacitance, the microprocessor 58 deactivates the pump 12 at block 606 and then returns to receiving zero-crossing signals from the signaling circuitry 70 at block 601. The process 600 thereafter repeats itself.

FIG. 7 depicts a detailed flowchart of an alternative process 700 performed by the microprocessor 58 for activating and deactivating the pump 12. The process 700 controls the level of the liquid 34 in the reservoir 26 utilizing a sump pump system 10 such as that described above. First, the microprocessor 58 receives a zero-crossing signal from the signaling circuitry 70 at block 701. Substantially immediately thereafter, the microprocessor 58 detects a capacitance generated by the capacitor 54 at block 702. Specifically, in the form of the sump pump system 10 discussed above, the capacitance is generated between the reference and detection electrodes 38, 40 and stored by the capacitance sensing IC 57. Therefore, the microprocessor 58 detects or reads the capacitance from the IC 57.

After the microprocessor 58 detects the capacitance, it determines whether the detected capacitance is equal to a predetermined upper limit capacitance at block 703. The predetermined upper limit capacitance corresponds to a capacitance generated by the electrodes 38, 40 when the level of the liquid 34 in the reservoir 26 is at the predetermined upper limit 30 shown in FIGS. 1 and 2. In the event the detected capacitance is equal to the upper limit capacitance, the microprocessor 58 activates the pump 12 at block 704 to move the liquid 34 out of the reservoir 26 via the discharge pipe 16. Specifically, in the form of the sump pump system 10 discussed above, the microprocessor 58 triggers or turns on the opto-triac 74 and the opto-triac 74 triggers or turns on the switch 76. This completes the circuit between the AC power supply and the pump 12 and allows the alternating current provided by the power supply to operate the pump 12. Once the microprocessor 58 activates the pump 12, it waits to receive another zero-crossing signal from the signaling circuitry 70 at block 701 and proceeds accordingly.

Alternatively, if the microprocessor 58 determines at block 703 that the capacitance detected at block 702 is not equal to the predetermined upper limit capacitance, the micro-processor 58 determines whether the detected capacitance is less than or equal to a predetermined trigger capacitance at block 705. The predetermined trigger capacitance is equal to a capacitance generated by the reference and detection electrodes 38, 40 when a surface of the liquid in the reservoir 26 is at a predetermined location below the upper limit 30 illustrated in FIGS. 1 and 2, but above the lower limit 32 illustrated in FIGS. 1 and 2. In one embodiment of the present invention, the trigger capacitance is measured when the surface of the liquid 34 in the reservoir 26 is approximately 1 inch below the upper limit 30. However, such trigger capacitance may be measured at virtually any location along the detection electrode 40 that is below the upper limit 30 and above the lower limit 32.

Nevertheless, if the microprocessor 58 determines at block 705 that the detected capacitance is not less than or equal to the trigger capacitance, the microprocessor returns to receiving zero-crossing signals from the signaling circuitry 70 at block 701. Alternatively, however, if the microprocessor 58 determines at block 705 that the detected capacitance is less than or equal to the trigger capacitance, it calculates a run-time at block 706.

The run-time is the amount of time that it took to pump down the liquid 34 in the reservoir 26 from the upper limit 30 to the predetermined location between the upper and lower limits 30, 32. The microprocessor 58 determines this run-time by monitoring the time that passed between when the microprocessor 58 determined the capacitance to be equal to the predetermined upper limit capacitance and when the microprocessor determined the capacitance to be equal to the trigger capacitance. In one form of the process 700, this determination may be made by using an internal clock in the microprocessor 58 to determine how much time has lapsed between the start of the pump and/or detection of the predetermined upper limit capacitance and detection of the trigger capacitance. However, it should be appreciated that the microprocessor 58 may determine this run-time in any effective manner which allows the microprocessor 58 to calculate the flow rate of the liquid 34 being moved out of the reservoir 26.

After determining the run-time at block 706, the microprocessor 58 calculates a total run-time at block 707. The total run-time is a factor of the run-time and corresponds to how long the pump 12 should remain activated to lower the level of the liquid 34 in the reservoir 26 to the predetermined lower limit 32 or some other desired level. In one form, the total run-time determined at block 707 is five times the run-time determined at block 706. Therefore, after the total run-time passes, the microprocessor 58 deactivates the pump 12 at block 708 and returns to receiving subsequent zero-crossing signals from the signaling circuitry 70 at block 701 and the process repeats itself accordingly.

While the above-described process 700 has been described as including a determination of a run-time and a total run-time, an alternate form of the process may include a determination of a flow rate at which the level of the liquid 34 drops between the micro-processor 58 detecting the upper limit capacitance and the trigger capacitance. In such a case, the microprocessor 58 would deactivate the pump 12 only after the pump 12 has removed a predetermined volume of liquid 34 out of the reservoir 26.

Additionally, it should be appreciated that while the above-described processes 600 and 700 have been described as including a series of actions described according to a sequence of blocks or steps, the present invention is not intended to be limited to any specific order or occurrence of those actions. Specifically, the present invention is intended to include variations in the sequences at which the above-described actions are performed, as well as additional or supplemental actions that have not been explicitly described, but could otherwise be successfully implemented.

Furthermore, in a preferred embodiment of the processes 600, 700 described above, the microprocessor 58 is programmed to activate the pump 12 for a minimum of four seconds and a maximum of sixteen seconds. Additionally, the microprocessor 58 is programmed to insure deactivation of the pump 12 for a minimum of one second between activation and deactivation. It should be appreciated, however, that such specific activation and deactivation periods are merely exemplary and that the microprocessor 58 may be programmed to accommodate various different sizes, models and configurations of pumps 12 and, therefore, these timings may also be changed to satisfy the desired conditions for any given application.

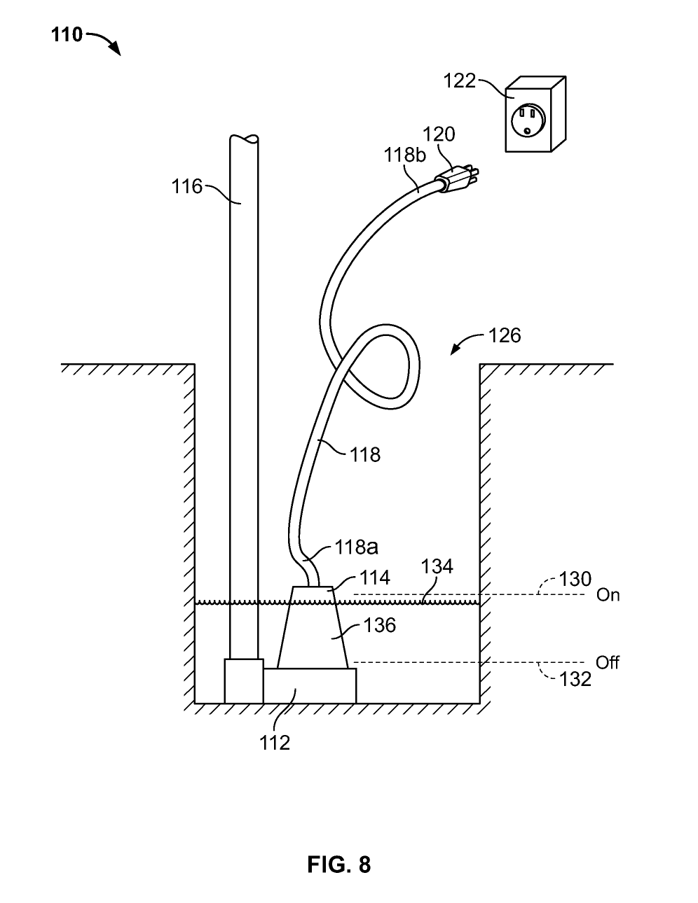

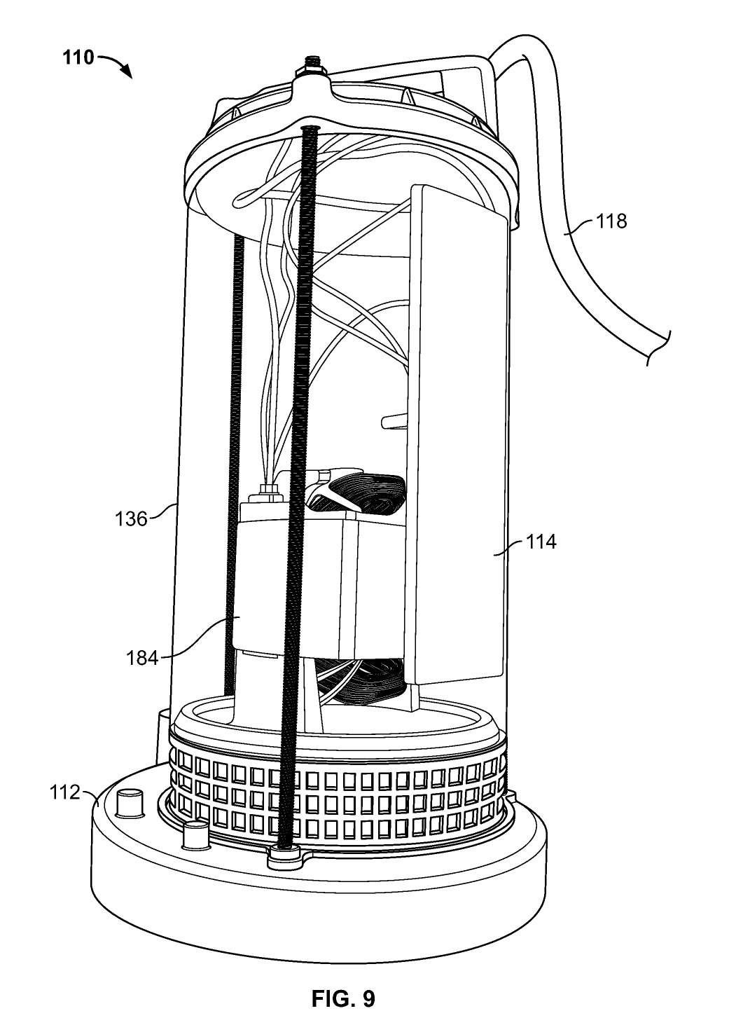

Referring now to FIGS. 8 and 9, alternative embodiments of systems are shown using a sensor in accordance with the invention. For convenience, features of the alternate embodiments illustrated in FIGS. 8-9 that correspond to features already discussed with respect to the embodiment of FIGS. 1-7 are identified using the same reference numerals in combination with the prefix “1” merely to distinguish one embodiment from the other, but otherwise such features are similar. In this form, sump pump system 110 includes a pump 112 powered by a motor 184, a sensor unit 114, and a liquid discharge pipe 116. Unlike the sump pump system 10 described above, the pump 112 and the sensor unit 114 are an integral unit sharing a common power cord 118. The power cord 118 includes an originating end 118a fixed to the sensor unit 114 and a terminal end 118b connected to a plug 120. The plug 120 is adapted to be electrically connected to a standard electrical outlet 122, similar to that described above with reference to the first embodiment of the sump pump system 10. Therefore, while the electrical connection between the sensor unit 14 and the pump 12 described in accordance with the first embodiment of the sump pump system 10 was achieved externally via the different cords, the same electrical connection is made in the sump pump system 110 of this alternative embodiment internally. Specifically, the sensor unit 114 and the pump 112 are hard-wired together and constructed as a single operational unit. Otherwise all features, characteristics and functions are generally the same as described above regarding the first embodiment and will not be described in detail again.

In the form illustrated, the capacitor is disposed in the housing 136 of the pump 112 and uses an outer wall of the housing 136 as part of the dielectric and the liquid level of liquid 134 with respect to the housing 136 to affect the dielectric performance and capacitance of the variable capacitor of capacitive sensor 114. Thus, when the liquid level of liquid 134 raises or lowers with respect to housing 136, a corresponding change in capacitance will be detected by sensor 114. When the detected capacitance is equal to or greater than the capacitance associated with the predetermined upper limit 130, the pump will be activated to evacuate liquid out of the reservoir 126 until the liquid 134 has dropped below a desired lower limit 132.

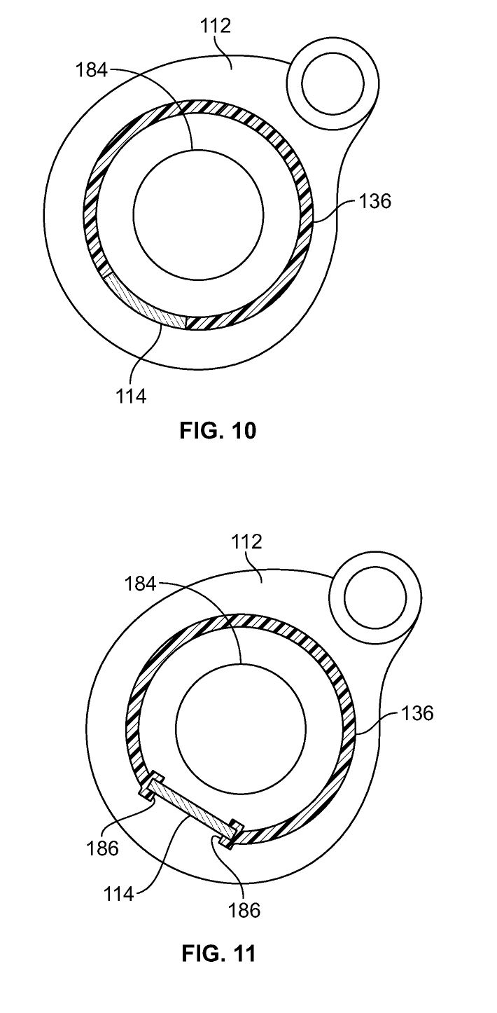

In the forms illustrated in FIGS. 9-11, the sensor 114 is disposed in the outer wall of the housing 136 and at least a portion of the outer housing is shown in transparent so that the internal components and sensor 114 can be seen therein. In one form shown in FIGS. 9 and 10, the sensor 114 may be molded directly into the housing wall 136. Alternatively, the sensor 114 may be coupled to the housing by fitting into a slot 186 formed in the housing wall 136. The sensor 114 may have an arcuate configuration to match the curvature of the housing wall 136, as shown in FIG. 10, or it may have a flat configuration, as shown in FIG. 11. The configurations described above are merely examples in accordance with the present invention, and other configurations are contemplated, as would be apparent to those skilled in the art.

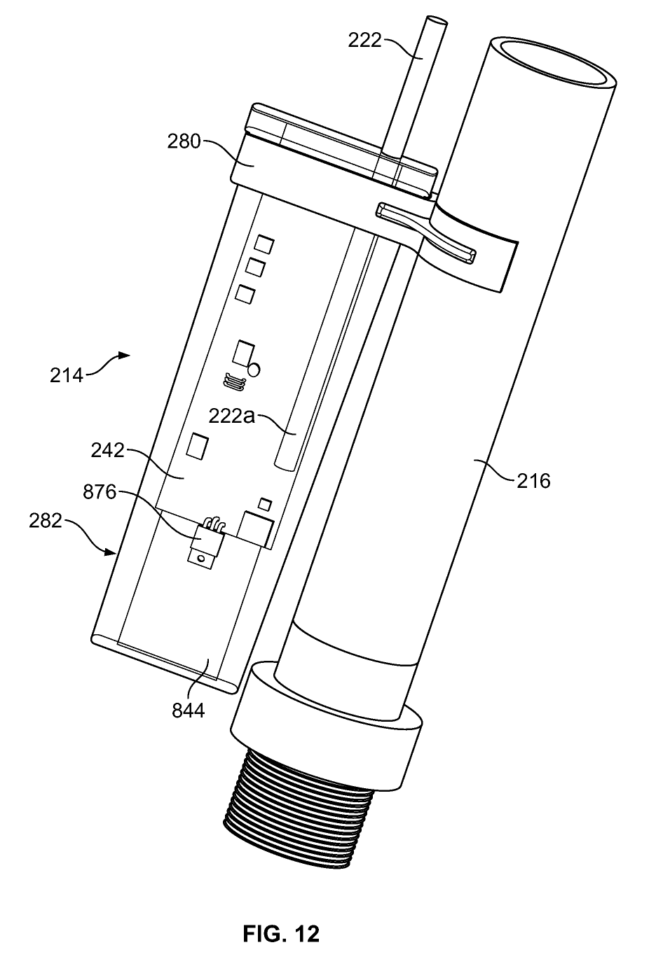

Another embodiment of the pump sensor is illustrated in FIG. 12 and, for convenience, features of this embodiment that correspond to features already discussed with respect to the embodiment of FIGS. 1-11 are identified using the same reference numeral in combination with the prefix “2” merely to distinguish one embodiment from the other, but otherwise such features are similar. In the form illustrated, the capacitive sensor 214 is shown connected to the discharge pipe 216 via a mounting bracket 280. The bracket 280 allows the sensor 214 to be positioned at any desired location on the discharge pipe 216, which allows the operator to determine how much liquid he or she wishes to maintain in the reservoir (not shown). For example, if an operator wishes to maintain a larger amount of liquid in the reservoir, the operator may slide the sensor 214 up the discharge pipe 216 and away from the pump (not shown) so that the predetermined upper limit for the liquid level is reached more slowly. Conversely, if the operator wishes to maintain less liquid in the reservoir, the operator may slide the sensor 214 down the discharge pipe 216 closer to the pump so that the predetermined upper limit for the liquid level is reached faster. In this way, the bracket 280 further allows the operator or installer to account for reservoirs or pits of different sizes and configurations.

An alternate housing 282 is also used for the sensor 214. In the form illustrated, the housing 282 forms more of an elongated sleeve with a longitudinal axis running generally parallel to the pipe 216. In this drawing the housing 282 is shown as being partially transparent so that the circuit board 242 and power cord end 222a of piggyback cord 222 are visible through the housing 282. In a preferred form, however, the housing 282 will be opaque and filled with a suitable potting material for protecting the circuit and circuit components on circuit board 242 from exposure to the liquid in which the sensor 214 is immersed. With this configuration, the length of the housing may be selected based on the pump application. For example, if a longer level sensor plate is desired so that the capacitor may track a larger range of liquid levels, the housing 282 can be elongated to accommodate the larger level sensor plate.

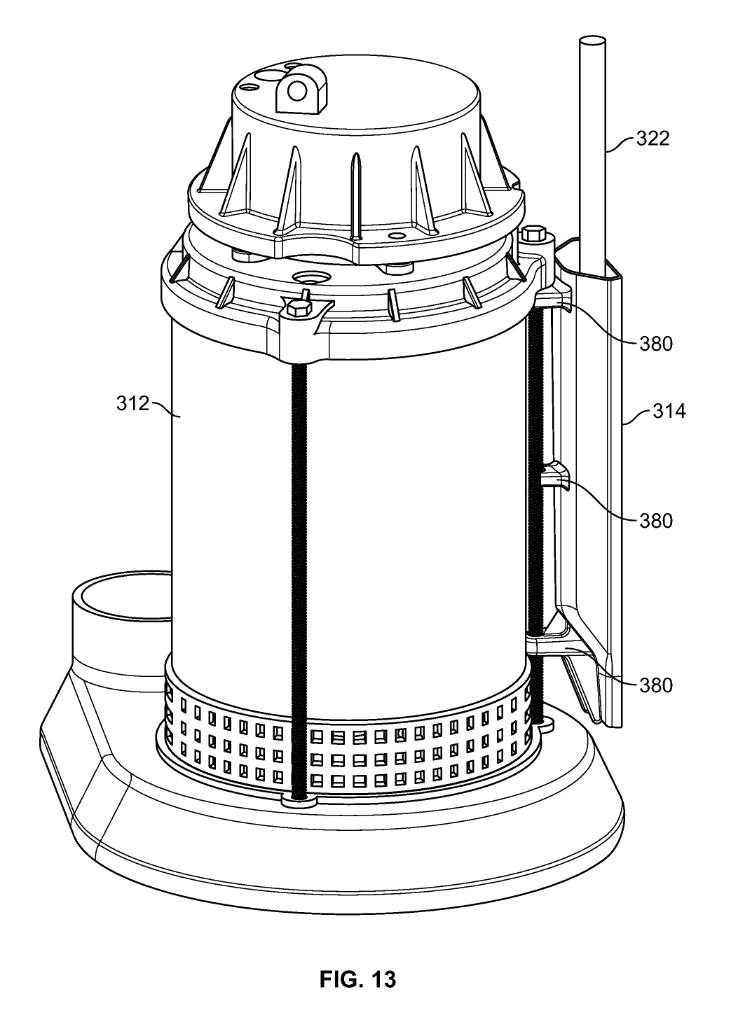

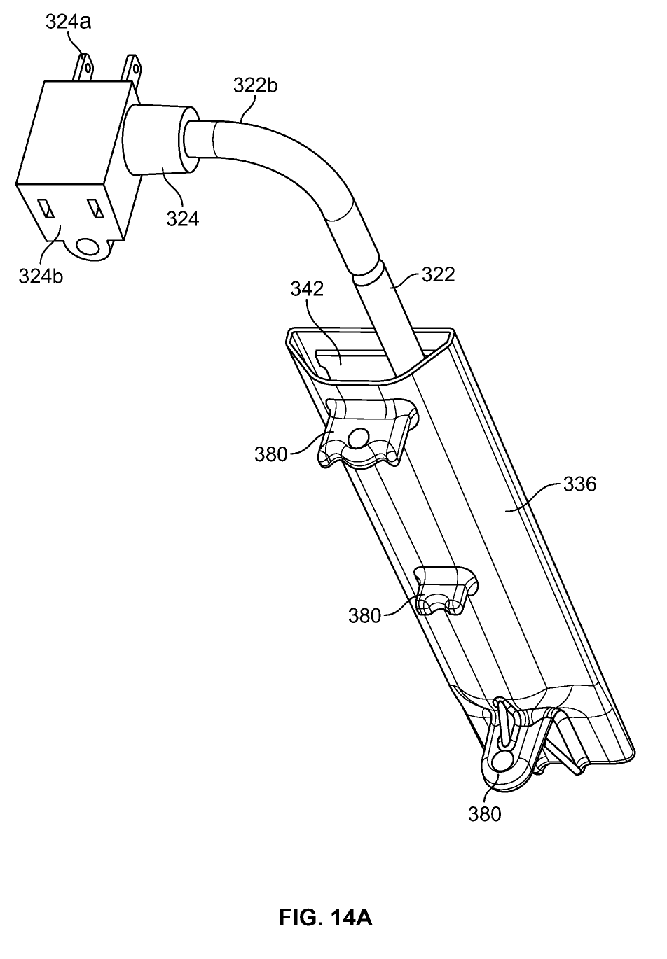

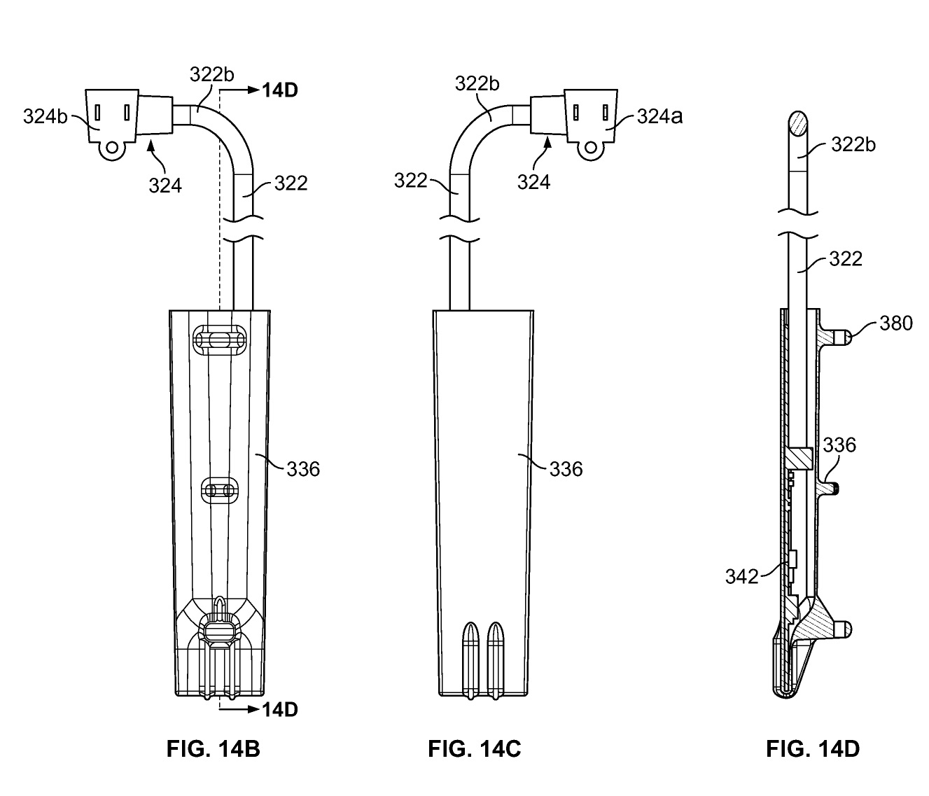

Yet another embodiment of the sensor and configuration for the pump and sensor are illustrated in FIGS. 13 and 14A-14D. As has been done before, features of this embodiment that correspond to features already discussed with respect to the embodiment of FIGS. 1-11 are identified using the same reference numeral in combination with the prefix “3” merely to distinguish one embodiment from the other, but otherwise such features are similar. In the form illustrated, the sensor 314 is connected to the pump 312 via a plurality of mounting brackets 380. Although a hollow housing 336 is illustrated so that the circuit board 342 may be seen, the housing 336 will preferably be filled with a potting material to protect the circuit and components on the circuit board 342 from the liquid in which the sensor 314 will be disposed.

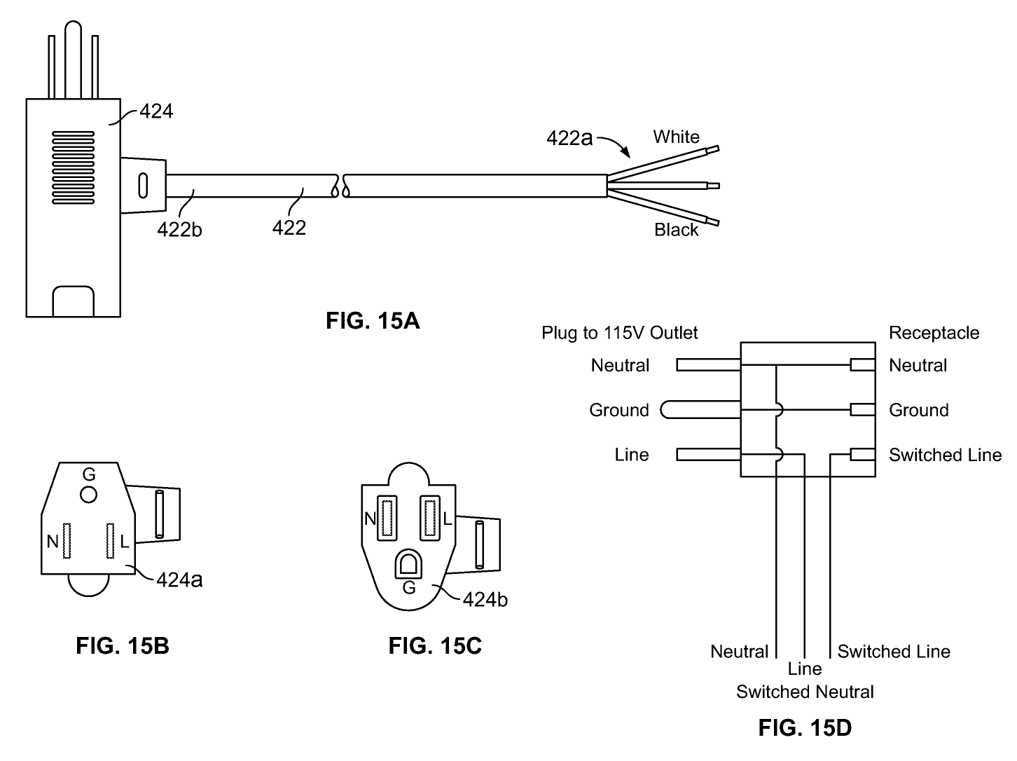

FIGS. 15A-15D illustrate one form of a piggyback power cord 422 for use with the embodiments illustrated herein and provide a wiring schematic for same. It should be understood, however, that alternate forms of piggyback cords may be provided so long as these cords allow the pump control disclosed herein to complete the circuit between the pump and the power source when a desired liquid level has been reached to activate the pump and break the circuit between the pump and power supply to deactivate the pump.

Although the embodiments illustrated thus far have had the level sensor plate (e.g., 30, etc.) of capacitor 33 located on top and the reference plate (e.g., 32) of capacitor 33 located below the level sensor plate, it should be understood that in alternate embodiments, the level sensor plate may be located below the reference plate. Such a configuration may be particularly advantageous in applications wherein a very minimal amount of liquid is to be monitored and/or maintained. For example, by placing the level sensor plate in the bottom of the capacitive sensor, liquids may be monitored and maintained much closer to the bottom of the pump and/or the bottom surface of the reservoir. In some applications, however, such a configuration will not be desired due to high contamination levels in the liquid causing deposits and/or foaming on the surface of the housing of the sensor opposite the level sensor plate or due to residual surface moisture lingering or being present on the surface of the housing of the sensor opposite the level sensor plate.

These and other concerns may also provide grounds for taking the sampling capacitance at a position slightly below the upper limit and/or well above the bottom of the level sensor plate and calculating a run-time for the pump to operate rather than trying to detect exactly when the liquid has dropped to a desired level on the level sensor plate. For example, if the lower portion of the level sensor plate contains residual surface moisture, this moisture may affect the readings of the capacitor (e.g., 33) and cause the pump control to continue to operate as if the liquid level has not dropped to the desired level on the level sensor plate because the residual water is affecting the capacitance reading of the capacitor.

In light of the foregoing, it should be understood that additional and/or supplemental features and processes are intended to be within the scope of the present invention. For example, the sensor unit 14 may include noise filtering components in order to ensure that the sensor unit 14 operates properly and efficiently. In another alternative form, a temperature sensor may be connected to the SSR 60 in order to limit the run-time of the pump 12. The temperature sensor may monitor the temperature of the opto-triac 74 and/or the switch 76 and, if the device gets too hot, direct the microprocessor 58 to deactivate the pump.

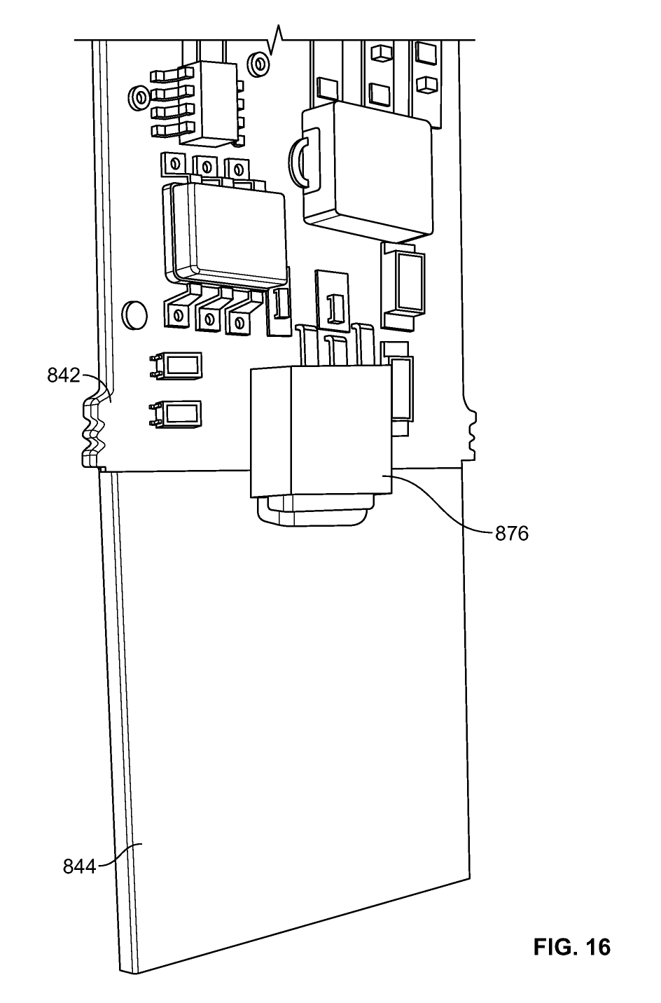

In a preferred form shown in FIGS. 12 and 16, a portion of the switch 76 discussed above, which is illustrated as triac 876 in these figures, is mounted to the circuit board 842 and another portion is mounted to a heat sink, such as a copper plate 844, to prevent the switch 876 from overheating. The heat sink is attached to the triac 876 using a surface mount reflow process, which can be undertaken at the same time that the other circuit components are being soldered to the circuit board. This process eliminates a separate process step as well as reduces labor time. In effect, the thermal metallization of the switching device 876 is operable as a thermal and mechanical bridge between the heat sink 844 and the circuit board 842. The heat sink is effectively connected to the circuit board 842 by the triac 876, which also eliminates the need for separate mounting hardware to mount the heat sink, thereby increasing production efficiency. The copper plate 844 is sized such that it has a relatively large surface area to effectively dissipate heat through the potting and sensor housing (not shown) and into the external environment. Preferably, the heat sink is located near the lower end of the housing so that it is more likely to be located below the liquid level. This way, heat produced by the circuit is transferred to the liquid. As a result, heat may be dissipated through the housing much more effectively, because liquid is a much better thermal conductor than air.

It should be noted that different applications and conditions may require the sensor and related components to be manufactured from different materials. For example, the materials used for the power cord and the potting for standard applications (such as sump applications) were found to be less suited for sewage applications. PVC or thermoplastic jackets used on power cords in testing were found to fail tests required to obtain sewage rating under applicable UL requirements. Upon experiment, it was found that rubber or thermoset jackets were preferable to PVC for sewage applications. In addition, the protective material, such as potting, used to protect the electric circuitry of the sensor in standard applications was less suited for sewage applications. However, no potting material suitable for a sewage application could be found that had the desirable flammability rating to meet UL requirements. Therefore, after much experimentation, it was found that using two different potting compounds arranged in layers was effective to meet both flammability and sewage requirements. Therefore, in a preferred form for sewage applications or other applications with similar conditions, the sensor electrical components are first covered with a first potting compound, and then a second potting compound is disposed on at least a portion of the first potting compound. The first potting material is preferably a flame retardant compound, such as EL-CAST FR resin mixed with 44 hardener, manufactured by United Resin. The second potting compound, which forms an outer layer disposed on the first, is preferably an acid-resistant potting compound, such as E-CAST F-28 resin mixed with LB26X92A hardener, also manufactured by United Resin. Thus, in a preferred form, the sensor housing is partially filled with the flame retardant potting compound, and then the second, acid resistant compound is poured into the housing such that the second layer is formed having an approximate thickness in the range of about ⅛ to ¼ inch. As mentioned above, in another form, the second potting compound may be the same composition as the first potting compound. In yet other forms, one or more protective materials effective to protect circuit components may be used as alternatives to one or more potting compounds, as would be apparent to one skilled in the art.

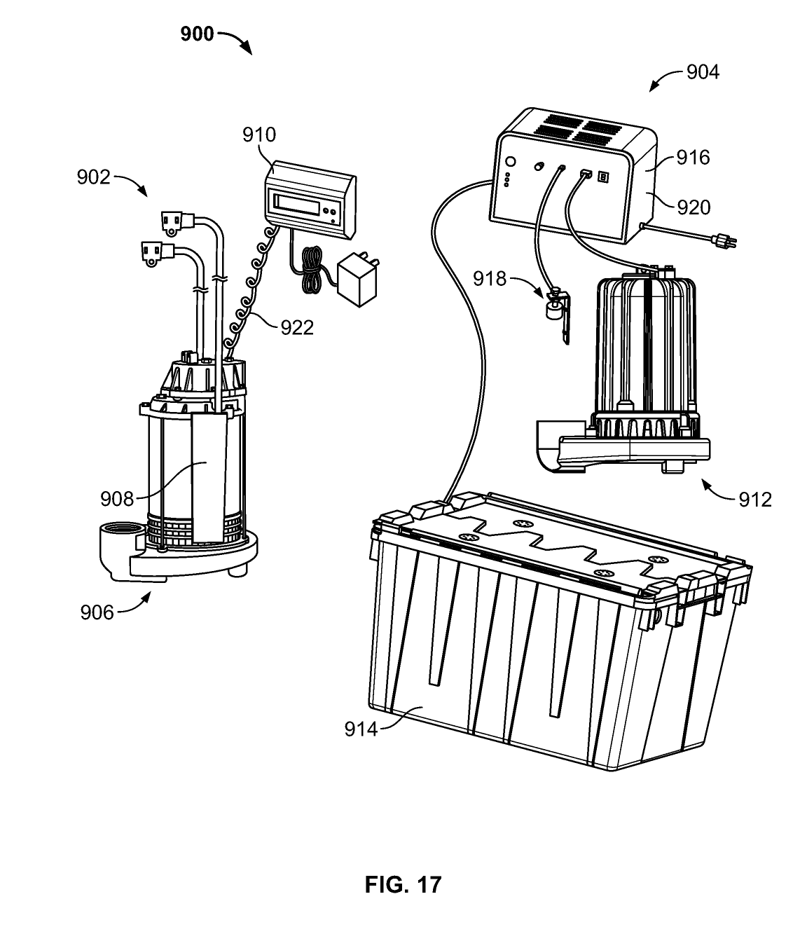

In one example of a typical sump application, the capacitive sensor may be implemented in a conventional battery back-up system. The purpose for the battery back-up in this instance is to allow the pump to continue to pump fluid even when main power is out in a residence or commercial facility. Thus, if the power did go out, the battery back-up system would supply power to the pump so that fluid could be evacuated in order to prevent flooding. Such systems also often include alarms that alert individuals to unusual pump operation, such as high water conditions, continuous running of the pump, overheating pumps, low battery, etc. These alert systems can be hard wired between the pump system and a display or can be wirelessly connected using a transmitter and receiver setup. Typically, the hard wired systems use telephone cable 922 (see FIG. 17) for connecting the pump system to the display and the wireless systems use radio frequency transmitters and receivers. In alternate embodiments, however, other types of cable may be used to hard wire the alert system and other types of convention wireless transmission techniques can be used such as infrared, Bluetooth, etc. In yet other embodiments the wireless system may be connected to a network, such as a LAN or WAN network, so that alerts can be sent via a local area network such as a server or a wide area network such as the Internet.

In another embodiment illustrated in FIG. 17, the capacitive sensor may be used in a dual pump system 900, such as one having primary and backup pump systems 902, 904. The primary pump system 902 may include a first pump 906 acting as the primary pump, a liquid level sensor, such as a capacitive sensor 908 as described in detail above, and a wired or wireless transmitter for communication with a remote receiver 910 of the pump system 900. The backup pump system 904 includes a second pump 912 acting as a backup, in case of either the failure of the first pump 906 or a power outage as discussed above. The secondary pump 912 is preferably battery-operated, such as a 24-volt direct current (DC) pump. The backup pump system may also include a battery bank or back-up 914 for powering the secondary pump 912, a battery charger 916, a float switch 918, a transmitter 920 and a backup pump controller. The backup system 904 may operate by turning on the secondary pump 912 whenever the liquid level triggers the float switch 918, which is normally placed above the regular high liquid level setting of the primary pump 906. Thus, the backup pump 912 is triggered whenever the liquid raises high enough to trigger the float switch 918, which occurs when the primary pump 906 is not pumping liquid at a sufficient flow rate, such as when the primary pump 906 lacks power or is inoperable, clogged, frozen, etc.

The pump system 900 may include an alert system, which includes the remote receiver 910. The remote receiver 910 may be wired or wireless, and is operable to receive information about the status of the system 900 from one or more transmitters of the system and indicate to the user various system conditions, such as when the primary pump 906 has no power or the liquid sensor (such as the capacitive sensor 908) is sensing a high water level, when the backup pump 912 is running or inoperable, when the battery 914 is low, or when the float switch 918 is sensing high liquid level. In addition, the receiver 910 may indicate when its own battery power is low or dead, or when the receiver 910 has lost AC power. The features described above are meant for illustrative purposes only, as one of ordinary skill in the art would contemplate the numerous applications in which the capacitive sensor described above could be implemented.

In addition, the capacitive sensor discussed herein may be implemented with pumps having known features such as cast iron impellers, top suction intakes, carbon/ceramic shaft seals, and stainless steel motor housing and impeller plates. Further, the sensor may be implemented with pump systems having features such as automatic battery recharging, battery fluid and charge monitors, and controls to automatically run the pump periodically to ensure operation. These and other items are disclosed and claimed in prior pending U.S. patent application Ser. No. 12/049,906, filed Mar. 17, 2008, which claims benefit of U.S. Provisional Application No. 60/919,059, filed Mar. 19, 2007, which are both hereby incorporated herein by reference in their entirety.

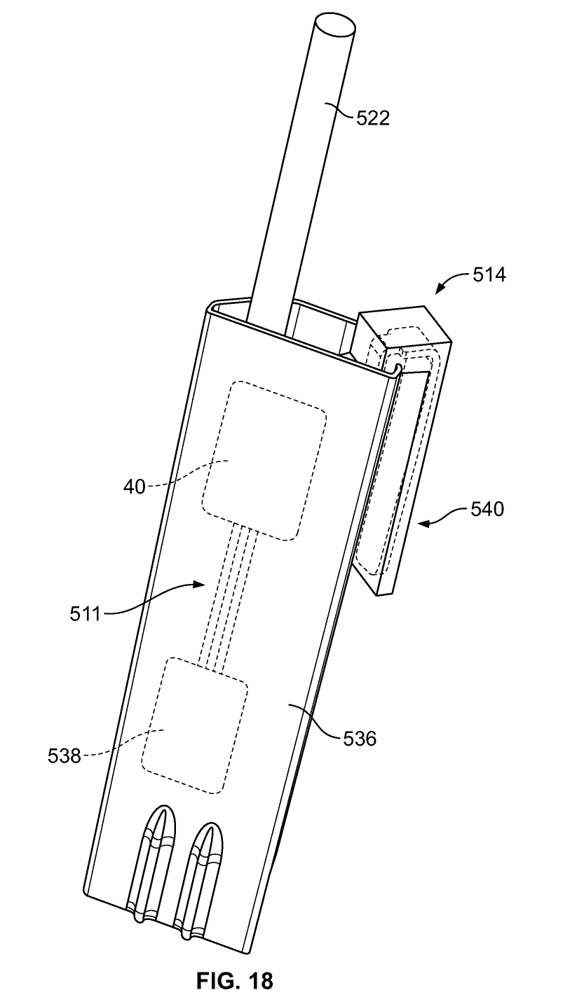

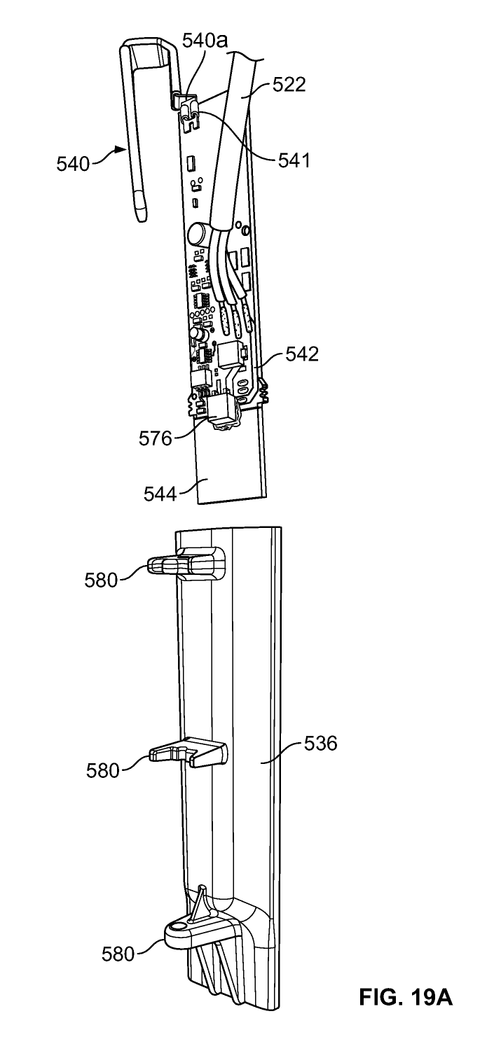

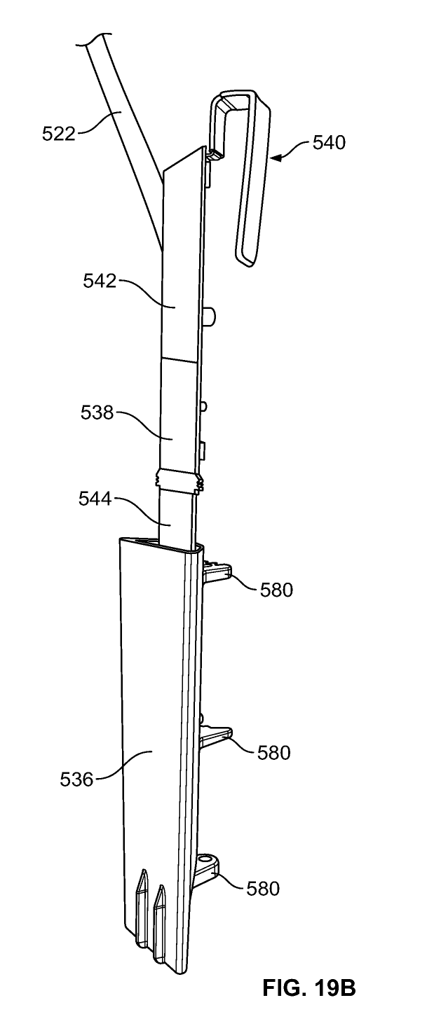

Turning now to FIGS. 18 and 19A-B, there is shown an alternate form of a pump sensor which is similar to that of the sensor 314 of FIGS. 13 and 14A-D. For convenience, features of this embodiment that correspond to features already discussed with respect to the embodiments of FIGS. 1-17 are identified using the same reference numeral in combination with the prefix “5” merely to distinguish one embodiment form the other.

In this form, the detection electrode 40 has been moved to an external position outside of sensor housing 536 to form an external detection electrode or probe 540 (or has been replaced with such an external detection electrode or probe 540). At least a portion of the external detection electrode 540 or the connection that connects it to the sensor 514 extends out of the fluid within which the sensor 514 is immersed to create a gap between the detection electrode 540 and housing 514 within which the reference electrode 538 is disposed to prevent the buildup of conductive materials between the reference electrode 538 and the detection electrode 540 for sensor 514, or at least minimize the effect of same. For example, in some environments containing highly conductive fluids or fluids with entrained or dissolved minerals therein that are conductive, such as for example sewage applications or other pump applications where conductive materials such as minerals can form between the capacitor electrodes, the remote or external positioning of electrode or probe 540 reduces the likelihood that conductive particles will collect between the terminals and thereby affect the ability of the capacitor, sensor and/or pump control to accurately measure capacitance based on the level of fluid making up at least a portion of the dielectric.

More particularly, in some environments containing such conductive fluids, minerals can collect between the reference electrode 538 and the detection electrode 540 of sensor 514 creating a bridge, such as salt bridge 511, between the two electrodes which can interfere with the ability of sensor 514 to determine when the pump 312 (FIG. 13) should be turned on and/or off and may result in the pump 312 operating continuously or nearly continuously when in fact the high water position 30 (FIG. 1) has not been reached and the pump does not need to be operating. Thus, by moving the detection electrode 540 outside of the housing 536, separating it from the reference electrode 538 and creating a connection between the detection electrode 540 and the reference electrode 538 that extends above the fluid within which the sensor 514 is immersed, the sensor 514 eliminates the possibility that (or at least greatly reduces the likelihood that) minerals will collect to form a salt bridge between the reference electrode 538 and detection electrode 540. This configuration allows the sensor 514 to function as desired in highly conductive fluids and the ability to function correctly when the sensing surfaces have been coated with an electrically conductive film on the surface of the sensor 514 or between the electrodes 538 and 540.

For convenience, the reference electrode 538 and original detection electrode 40 are shown in broken line to illustrate their approximate location on the inner wall of the sensor housing 536. It should be understood, however, that these electrodes are positioned on the rear side of circuit board 542, adjacent the inner wall of the sensor housing 536 and that the salt bridge 511 actually forms on the outer wall of the sensor housing 536 (which is a part of the dielectric of the capacitive sensor 514 as discussed above). Although this form is illustrated with the detection electrode 540 moved outside of or external to the capacitive sensor housing 536 it should also be understood that in alternate embodiments the reference electrode 538 could be moved outside of the sensor housing 536 instead of the detection electrode 540 or two separate housings could be provided for each electrode 538, 540 with a gap or spacing between the separate electrode housings. It should also be understood that in alternate embodiments the circuit to which the electrodes are connected does not need to be located in the same housing as either of the electrodes. For example, in an alternate form, the sensor 514 may be configured with the circuit located outside of the fluid and the two electrodes in their own respective housing, with the reference electrode housing being immersed in the fluid and the detection electrode housing being positioned separate and apart from the reference electrode so that it is at least partially immersed in the fluid as the fluid reaches the maximum desired fluid level. In yet other forms, the circuit and reference electrode may be positioned within the housing of pump 312 with the detection electrode located in its own housing positioned separate and apart from the housing of pump 312.

As with the embodiment illustrated in FIGS. 13-14D, the sensor 514 is connected to the pump 312 via a plurality of mounting brackets 580. Furthermore, although a hollow housing 536 is illustrated so that the circuit board 542 may be seen, the housing 536 will preferably be filled with a potting material to protect the circuit and components on the circuit board 542 from the liquid in which the sensor 514 will be disposed and/or to hold the circuit board 542 in place inside housing 536. In addition, in a preferred form, the reference electrode 538 will be positioned proximate to the inner wall of housing 536 such that no air gap is formed between the electrode 538 and the housing wall 536. For example, in the form illustrated, the reference electrode 538 is positioned adjacent the inner wall of housing 536 such that it abuts the inner wall of housing 536 over a large portion of its surface area.

Likewise, as discussed above, in a preferred form a portion of the switch 76 (e.g., high current triac 576 in these figures), is mounted to the circuit board 542 and to a heat sink, such as copper plate 544, to prevent the switch 576 from overheating. The heat sink is attached to the triac 576 using a surface mount reflow process and, in effect, the heat sink is effectively connected to the circuit board 542 by the triac 576. The copper plate 544 is preferably sized such that it has a relatively large surface area to effectively dissipate heat through the potting and sensor housing 536 and into the external environment. In one form, the heat sink is preferably located near the lower end of the housing 536 so that it is more likely to be located below the lower fluid level 32 (FIG. 1) of the environment and the heat produced by the circuit is transferred from the heat sink 544 to the liquid within which the pump is immersed. As a result, heat may be dissipated through the housing much more effectively, because liquid is a much better thermal conductor than air.

In the embodiment illustrated in FIGS. 18-19B, housing 536 defines a vertical longitudinal axis and the external probe 540 is in the general form of an inverted U or J-shape and is made of conductive material such as metal and has an insulative polymer coating such as a plastic or rubber coating. The inverted J-shape allows the external probe 540 to extend upward out of a top opening in the upper portion of housing 536 and outward from the sensor housing 536 and back down toward the lower portion of the housing 536 generally parallel to the exterior surface of housing 536 while maintaining a generally constant spacing or gap between the external probe 540 and the exterior of the housing 536. With this form, the upper most portion of the external probe 540 remains out of the fluid within which the sensor 514 is inserted so that only the distal end of the external probe 540 extends back down into the fluid (or at least extends into the fluid when the fluid is approaching or at the high fluid mark 30 depicted in FIG. 1). Thus, with this design, there is no portion of housing 536 located between the electrodes 538 and 540 upon which minerals could deposit to form salt bridge 511.

In the form illustrated, the originating end 540a of probe 540 has a male terminal or connector for mating to a female coupling or connector 541 located on and electrically coupled to the circuit on the printed circuit board 542. Thus, with this form, even existing sensors made to the specification of the sensor depicted in FIGS. 13-14D can be retrofitted with the external probe 540 of sensor 514 so that the original detection probe 40 can be disconnected and/or the electrical circuit can be re-routed to electrically connect to the external probe 540 instead of original probe 40 to prevent mineral buildup between the electrodes 38 and 40. Once the circuit board 542 is inserted into the cavity defined by housing 536 a filler such as potting compound may be inserted into the cavity to seal and protect the circuit 542 and electrical components thereon from the fluid of the surrounding environment that sensor 514 is used in. In a preferred form a standoff, such as a foot member, may be used to maintain spacing of the external probe 540 from the wall of sensor housing 536 so that the probe 540 is adequately surrounded by potting compound and to prevent the probe 540 from coming in contact with the housing 536 so that no mineral buildup or salt bridging can form between the electrodes 538 and 540. The standoff can be positioned on either the inner wall of the housing 536 or on the external probe 540 itself. For example, in a preferred form a foot member or protrusion is positioned on the initial vertical portion of the probe 540 extending up from the male terminal of originating end 540a to space the probe 540 from housing 536. This protrusion is positioned low enough on the probe to ensure that it will be fully encapsulated by the potting compound so that no external portions of the probe 540 and the housing 536 are in physical contact with one another. The probe 540 then continues to extend up vertically from the top opening of the upper portion of housing 536 and then bends out over the edge of the sensor housing 536 and back down at its terminal end toward the lower end of housing 536, generally parallel to the exterior surface of housing 536. This allows the terminal end of the probe 540 to be immersed in the fluid, but to maintain a portion above the fluid to ensure physical separation between the electrodes 538 and 540.

It should be understood that the external probe 540 may be designed in a variety of different shapes and sizes in accordance with the embodiment discussed in FIGS. 18-19B so long as the probe is located remote from or external to the housing 536 and designed with a least a portion of the probe 540 or connection between the probe 540 and sensor 514 extending above the high fluid level 30 (FIG. 1) of the fluid within which the sensor is immersed so that minerals do not collect between the detection electrode 540 and the reference electrode 538. For example, in one embodiment the probe 540 may consist of nothing more than a metal plate located at the distal end of a mount or bracket in the same shape of the probe illustrated in FIGS. 18-19B. Similarly, in alternate embodiments the external electrode or probe 540 may not only take on different sizes or shapes but may also be mounted in a variety of different ways and to a variety of different objects and surfaces, such as the sensor 514, the pump 312 (FIG. 13), the discharge valve 216 (FIG. 12) or other structures in the environment within which the sensor 514 is inserted. For example, in the form illustrated in FIGS. 18-19B, the external sensor 540 is directly mounted to the sensor 514. In an alternate form, the external sensor 540 may be mounted elsewhere on the pump 312 and simply wired to the circuit board 542 of sensor 514. In yet another form, the external sensor 540 may be mounted to the discharge pipe 216 (as the sensor 214 was in FIG. 12). In still other forms, the external probe 540 may be mounted to a wall of the reservoir 26 illustrated in FIG. 1 and electrically connected to the sensor 514 either by insulated wire or some other conventional form of electrical connection.

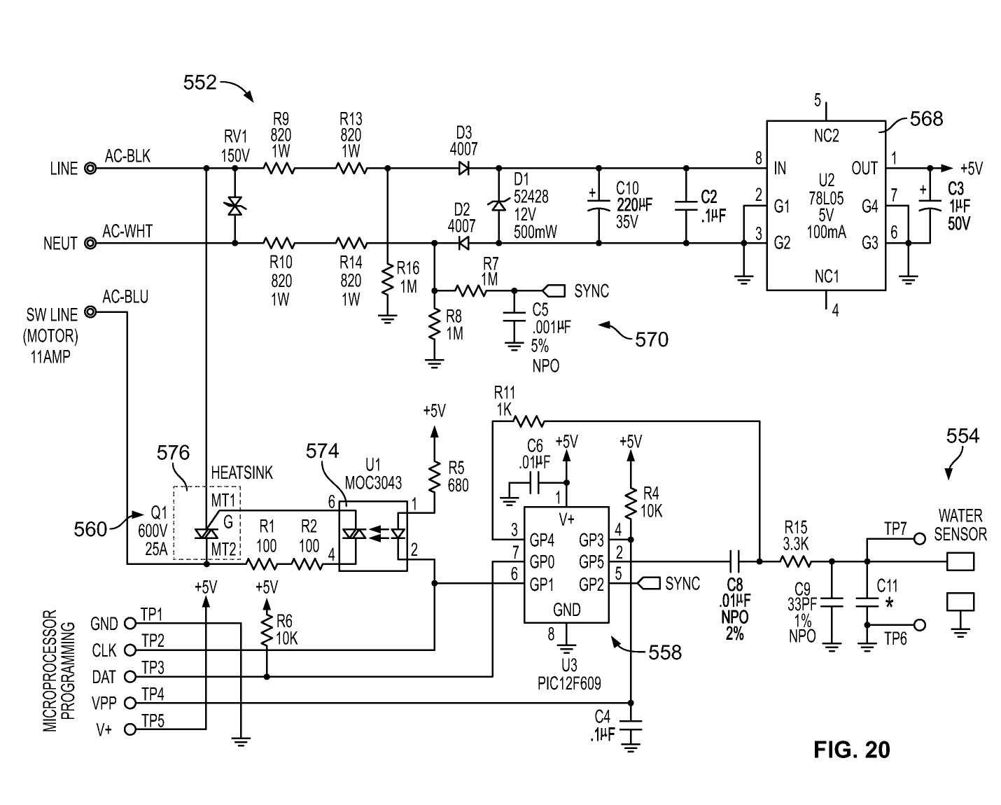

In FIG. 20, a schematic diagram is illustrated of an alternate circuit for sensor 514. In this form, the circuit on circuit board 542 includes a power supply 552, a capacitive sensor 554, a controller, such as microcontroller 558, an AC switch 560, and signaling circuitry 570. The capacitive sensor 554 tells the controller 558 when to turn the pump 312 on and the controller 558 turns on the pump 312 via the opto-triac 574 and high current triac 576 which supplies AC power to the pump 312. The operation of the circuit is very similar to that of the circuit described above with respect to FIGS. 4A-5, but in this circuit the separate microcontroller 58 and sensor IC of cap sensor 54 in FIG. 4A have been combined into one microcontroller 558. In a preferred form, the controller 558 is programmed to activate the pump 312 for a minimum of four seconds and a maximum of sixteen seconds. Additionally, the controller 558 is programmed to insure deactivation of the pump 312 for a minimum of one second between activation and deactivation. It should be appreciated, however, that such specific activation and deactivation periods are merely exemplary and that the controller 558 may be programmed to accommodate various different sizes, models and configurations of pumps 12 and, therefore, these timings may also be changed to satisfy the desired conditions for any given application.

It should be understood, however, that in alternate embodiments the circuit could be programmed to operate in any of the different manners discussed above (e.g., as described with respect to FIG. 6, FIG. 7, etc.) or as contemplated herein. For example, the circuit could be programmed to operate the pump 312 until a predetermined lower limit capacitance is detected indicative of the low water level 32 (FIG. 1), or to determine a run-time that the pump 312 should be operated for, or to determine a flow rate based on the amount of fluid that has been evacuated by the pump 312 over a period of time in order to determine a pump operation period, etc. Similarly, it should be appreciated that while the above-described processes have been described as including a series of actions described according to a sequence of flow chart steps, the present invention is not intended to be limited to any specific order or occurrence of those actions. Specifically, the present invention is intended to provide options for end product designers and allow for variations in the sequences at which the above-described actions are performed, as well as additional or supplemental actions that have not been explicitly described, but could otherwise be successfully implemented.

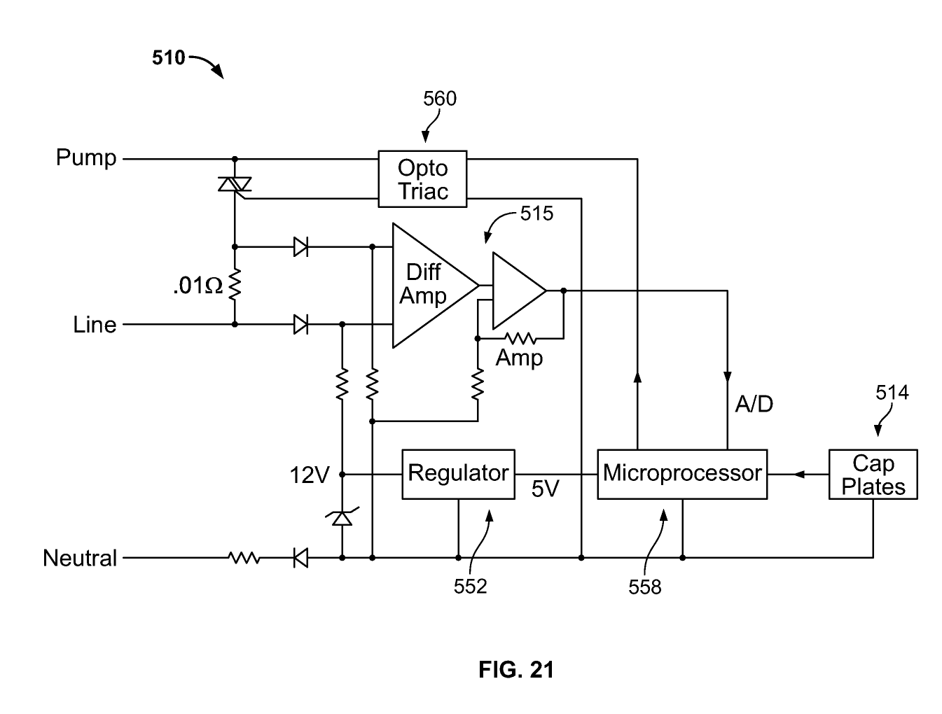

In yet another form of the invention, however, the pump control 510 may be designed to actuate the pump 312 using a first type of sensor and to turn off the pump using a second type sensor different from the first. For example, in the block diagram illustrated in FIG. 21, pump control 510 uses capacitive sensor 514 to tell the controller 558 when to turn on the pump 312, but uses a different type of sensor, i.e., current sensor 515, to tell the controller 558 when to turn off the pump. In this form, the controller 558 actuates the pump 312 via AC switch 560 and then waits a very brief amount of time to determine what the normal or base line average current is during the initial pump operation period. The purpose for waiting a brief amount of time after actuating the pump is to account for current stabilization (e.g., waiting half a second or so should account for any initial current spikes that occur from actuating the pump). Then, once the controller 558 detects that the current has changed via current sensor 515, such as for example ten percent below the base line, it is assumed that the pump 312 is running out of fluid to evacuate from the area and thus the controller 558 shuts off the pump 312. An advantage to using current sensor 515 to shut the pump 312 off is that there are no calculations or estimates that need to be made to determine how long to run the pump 312 or how long it will take to evacuate the desired area of fluid. Rather, the current sensor 515 allows the controller 558 to determine exactly when the pump 312 has successfully evacuated the desired amount of fluid from the area and then shut the pump 312 off.

In the current sensor form illustrated, a very small resister is placed in series with a differential amplifier to sense current by monitoring the voltage across that resister. A 0.01 Ohm resister is shown for use in applications utilizing a 5-10 Amp motor. This 0.01 Ohm resister will give 100 mV of signal for a 10 Amp current which is within the desired range voltage signal. In other forms, alternate resister values may be used to ensure that the differential amplifier of current sensor 515 is triggered once the desired current has been reached. For example, a 0.020 or 0.025 Ohm resister may be used for a 3 Amp motor driven pump. Thus, the components selected will preferably be determined based on the size of the motor that is to be used in conjunction with the sensor and pump control. In addition to what is shown in the block diagram of FIG. 21, a rectification circuit could be used in conjunction with the op amp located behind the differential amplifier in order to convert the AC signal to a DC voltage. Alternatively, given how fast microprocessors have become, the AC voltage could be measured at its peak at a zero crossing without needing to rectify the signal. Once the current sensor indicates a ten percent decrease in current from the base line current average, the controller 558 determines the low fluid limit has been reached and shuts off the pump 312. It should be understood, however, that the pump controller 510 of FIG. 21 may be configured to operate at different ranges or with different values and limits. For example, some highly efficient motors might show the current change as a fifty percent reduction or more when the low water limit has been reached while other shaded pole motor may only show a ten percent reduction. Thus a reduction in excess of ten percent may be used to trigger the controller to shut of the motor on one application while a reduction of anywhere between ten to seventy-five percent may be used to trigger the controller to shut off the motor in other applications.

In still other forms of the invention, a first capacitive sensor may be used to turn on the pump and a second sensor, such as a thermal or temperature sensor, may be used to turn off the pump via the detection of heat indicative of the pump having evacuated enough fluid from a reservoir or space. For example, a thermal sensor may be used to detect the fact that the pump is running hotter because it has evacuated all or most of the fluid it was activated to evacuate. Once this rise is temperature is detected (or a predetermined temperature is reached), the thermal sensor would tell the controller to shut off the pump and the pump would remain off until the capacitive sensor tells the controller to activate the pump again. Examples of thermal or temperature sensors that may be used as the second sensor may be obtained from entities like Maxim Integrated Products, Inc. of Sunnyvale, Calif.

In another form, a first capacitive sensor may be used to turn on the pump and a second sensor, such as a speed or torque sensor, may be used to turn off the pump via the detection of a change in speed indicative of the pump having evacuated enough fluid from a reservoir or space. For example, a speed sensor may be used to monitor the speed with which the impeller of the pump (or impeller shaft) is rotating and upon the detection of a change in the speed of the impeller, may tell the controller to shut off the pump as enough fluid has been evacuated from the space. More particularly, the speed sensor may be used to monitor the speed of the impeller to confirm that it is evacuating fluid as desired. Once the impeller speed starts to increase, it is assumed that the amount of torque has dropped down below a predetermined level due to the lack of liquid for the vanes of the impeller to engage, thereby signaling that enough fluid has been evacuated and the pump may be shut off. The exact amount of speed and/or torque that triggers the shut off of the pump may be selected and varied depending on the type of fluid being evacuated by the pump or in what environment the pump is operating or depending on the size pump or motor being used, etc. For example, a higher speed setting may be monitored for in sump applications than in a sewage application due to the difference in friction or viscosity associated with the different fluids being pumped (e.g., the speed sensor may want to be set for a higher speed setting in sump applications than in sewage applications because gray water is lighter and less frictional or less viscous than sewage and thus a small remaining amount of gray water will likely allow for higher increases in speed than a similar small amount of remaining sewage, etc.). Similarly since torque multiplied by speed equals power, this form of sensor could be described as monitoring for a change in power (instead of describing it as speed or torque monitoring) and de-activating the pump when a certain power change has been detected.

In yet other forms, the controller may be programmed to shut off the pump upon the detection of a predetermined speed or upon the detection of a predetermined torque. For example, if the torque of the impeller shaft has dropped to (or below) a predetermined torque level it may be assumed enough fluid has been evacuated such that the pump may be shut off. Such a sensor is disclosed in U.S. Pat. No. 5,297,044 which is hereby incorporated by reference herein in its entirety. Other examples of speed/torque sensors that may be used as the second sensor may be obtained from entities like Electro-Sensor, Inc. of Minnetonka, Minn.

In still other forms, the second sensor may be implemented as a magnetic sensor, such as Hall Effect sensors. For example, a Hall Effect sensor may be used to detect current and shut off the pump once a specified current is reached as discussed above with respect to FIG. 21. In other forms, Hall Effect sensors may be used to detect motion or speed and to shut off the pump once specified speed is reached as mentioned above. Examples of Hall Effect sensors that may be used as the second sensor may be obtained from entities like Allegro MicroSystems, Inc. of Worcester, Mass.

Although the focus of the discussion thus far has been on apparatus, it should be understood that many methods are also disclosed herein utilizing the inventive concepts set forth above. For example, FIGS. 18-21 also disclose methods of determining fluid levels, methods of determining capacitance, methods of varying capacitance and methods of controlling and operating pumps using same. For example, FIGS. 18-19B disclose a method for reducing the effects of conductive minerals or fluids on a capacitive sensor. In addition, FIG. 21 discloses methods for controlling and operating a pump using a first sensor for activating the pump and a second sensor different from the first for de-activating the pump.

Finally, it should be appreciated that the foregoing merely discloses and describes examples of forms of the present invention. It should therefore be readily recognizable from such description and from the accompanying drawings that various changes, modifications, and variations may be made without departing from the spirit and scope of the present invention. For example, although the drawings show the capacitor and sensor discussed herein being used in a sump pump application, it should be understood that such a capacitor and sensor may be used in a variety of different applications and with a variety of different pieces of equipment including, but not limited to, dewatering, sewage, utility, pool and spa equipment, wired or wireless back-up pump systems, well pumps, lawn sprinkler pumps, condensate pumps, non-clog sewage pumps, effluent and grinder pump applications, water level control applications, as well as other non-pump related applications requiring liquid level control. In still other embodiments, the sensors, pump controls and systems described herein may be setup in an opposite manner to maintain a desired fluid level in an area by detecting when the fluid level has dropped to an undesirably low level and to automatically pump more fluid into the area to maintain the fluid at the desired level. For example, water evaporation is a problem with many pools and spas and often it is necessary to add water to a pool or spa to maintain the water at a desired level. In such cases, the sensors and pump controls described herein can be configured to monitor for a low water level condition and activate a pump to pump in water to maintain the water at the desired level. Similarly, the concepts disclosed herein can be used when dealing with DC motors and circuit applications instead of AC motors and circuit applications. For example, in a battery backup pump application using a DC motor and circuitry, the same capacitor, capacitive sensor and pump controls and/or two sensor systems could be used to operate the pump (albeit some components like triacs may be replace with alternate DC components like transistors).

What is claimed is:

1. A capacitive sensor comprising:
a sensor housing defining a cavity;
a capacitor having a first electrode located within the cavity of the sensor housing and a second electrode located at least partially external to the sensor housing thereby creating a gap between the second electrode and the sensor housing to reduce the risk of mineral buildup between the capacitor electrodes; and
a dielectric connecting the first and second electrodes to form a capacitor having a readable capacitance, the dielectric having a first part made of an insulative material and a second part made of a liquid having a level that changes with respect to the insulative material which causes a change in the capacitance of the capacitor.

2. The capacitive sensor of claim 1 wherein at least a portion of the sensor housing forms at least a portion of the insulative material of the dielectric and the second electrode is located completely external to the capacitor body so that there is at least a gap between the second electrode and the sensor housing to prevent salt bridges from forming between the electrodes.

3. The capacitive sensor of claim 2 wherein the sensor housing has a vertical longitudinal axis and defines an upper housing portion and a lower housing portion and the first electrode is located on an elongated circuit board inserted into the cavity of the sensor housing positioning the first electrode against an inner surface of the sensor housing at the lower housing portion thereof and the second electrode extends up from the elongated circuit board out of a top opening of the sensor housing at the upper housing portion thereof and outward from the sensor housing and extends back down towards the lower portion of the sensor housing generally parallel to an exterior surface of the sensor housing.

4. A capacitive sensor for immersing in a fluid with at least one external electrode for reducing the risk of mineral buildup between capacitor electrodes, the sensor comprising:
a sensor housing made up of an insulative material and defining a cavity within which a circuit is disposed;
a capacitor having a first electrode electrically connected to the circuit and located within the cavity of the sensor housing and a second electrode electrically connected to the circuit via an electrical connection and spaced apart from the sensor housing such that at least a portion of the electrical connection or the second electrode is positioned out of the fluid within which the capacitive sensor is immersed in order to create a physical separation between the second electrode and the sensor housing to reduce the risk of mineral buildup between the capacitor electrodes; and
a dielectric connected between the first and second electrodes to form a capacitor having a readable capacitance, the dielectric having a first part made of at least a portion of the insulative material of the sensor housing and a second part made of at least a portion of the liquid, the liquid having a level that changes with respect to the insulative material which causes a change in the properties of the dielectric and the capacitance of the capacitor.

5. A pump control with external probe comprising:
a housing defining a cavity;
a controller for actuating a pump connected to a circuit disposed in the cavity of the housing;
a capacitive sensor connected to the controller and having a first electrode probe disposed within the cavity of the housing and a second electrode probe positioned outside of the housing and electrically connected to the circuit within the housing; and
a switch connecting the controller to the pump and operated by the controller for actuating the pump.

6. The pump control of claim 5 wherein the circuit is disposed in the cavity of the housing such that the first electrode probe of the capacitor is positioned adjacent an inner surface of the housing defined by the cavity and the pump control is immersed in a fluid such that the portion of the housing adjacent the first electrode probe and the fluid within which the pump control is immersed make up at least a portion of the dielectric between the first and second electrode probes of the capacitive sensor and form a capacitor with a readable capacitance.

7. The pump control of claim 6 wherein the housing has a vertical longitudinal axis and defines an upper housing portion and a lower housing portion and the first electrode probe is located on an elongated circuit board inserted into the cavity of the sensor housing positioning the first electrode against the inner surface of the housing at the lower housing portion thereof and the second electrode extends up from the elongated circuit board out of a top opening of the housing at the upper housing portion thereof and outward from the sensor housing and extends back down towards the lower portion of the sensor housing generally parallel to an exterior surface of the sensor housing.

8. The pump control of claim 6 wherein the fluid has a level that changes with respect to the housing which causes a change in the capacitance of the capacitor and the controller actuates the pump when a high fluid position is detected via the capacitive sensor reading a capacitance of a predetermined amount.

9. A pump control comprising:
a first sensor using a first type of sensing for detecting a first fluid position;
a second sensor using a second type of sensing different from the first for detecting a second fluid position; and
a controller electrically connected to the first and second sensors and capable of activating a pump when the first sensor detects the first fluid position and de-activating the pump when the second sensor detects the second fluid position.

10. The pump control of claim 9 wherein the first sensor is a capacitive sensor that detects the first fluid position when a capacitance is detected that corresponds to a high fluid position and the second sensor is a current sensor, a thermal sensor, a speed sensor, a torque sensor or a Hall Effect sensor that detects the second fluid position when a current, a temperature, a speed, a torque or a Hall Effect condition is detected that corresponds to a low fluid position.

11. The pump control of claim 9 wherein the first sensor is a capacitive sensor that detects the first fluid position when a capacitance is detected that corresponds to a high fluid position and the second sensor is a current sensor that detects the second fluid position when a current is detected that corresponds to a low fluid position.

12. The pump control of claim 9 wherein the first sensor is a capacitive sensor that detects the first fluid position when a capacitance is detected that corresponds to a high fluid position and the second sensor is a thermal sensor that detects the second fluid position when a temperature is detected that corresponds to a low fluid position.

13. The pump control of claim 9 wherein the first sensor is a capacitive sensor that detects the first fluid position when a capacitance is detected that corresponds to a high fluid position and the second sensor is a speed or torque sensor that detects the second fluid position when a speed or a torque is detected that corresponds to a low fluid position.

14. The pump control of claim 9 wherein the first sensor is a capacitive sensor that detects the first fluid position when a capacitance is detected that corresponds to a high fluid position and the second sensor is a Hall Effect sensor that detects the second fluid position when a condition is detected that corresponds to a low fluid position.

15. A method of controlling a pump comprising:
providing a first sensor using a first type of sensing for detecting a first fluid position, a second sensor using a second type of sensing different from the first for detecting a second fluid position, and controller electrically connected to the first and second sensors;
activating a pump via the controller when the first sensor detects the first fluid position; and
de-activating the pump via the controller when the second sensor detects the second fluid position.

16. The method of claim 15 wherein the first sensor is a capacitive sensor and the second sensor is a current sensor, a thermal sensor, a speed sensor, a torque sensor or a Hall Effect sensor and activating the pump comprises turning on the pump when the capacitive sensor detects a capacitance that corresponds to a high fluid position and de-activating the pump comprises turning off the pump when the current sensor, thermal sensor, speed sensor, torque sensor or Hall Effect sensor detects a condition that corresponds to a low fluid position.

17. The method of claim 15 wherein the first sensor is a capacitive sensor and the second sensor is a current sensor and activating the pump comprises turning on the pump when the capacitive sensor detects a capacitance that corresponds to a high fluid position and de-activating the pump comprises turning off the pump when the current sensor detects a current that corresponds to a low fluid position.

18. The method of claim 15 wherein the first sensor is a capacitive sensor and the second sensor is a thermal sensor and activating the pump comprises turning on the pump when the capacitive sensor detects a capacitance that corresponds to a high fluid position and de-activating the pump comprises turning off the pump when the thermal sensor detects a temperature corresponding to a low fluid position.

19. The method of claim 15 wherein the first sensor is a capacitive sensor and the second sensor is a speed or torque sensor and activating the pump comprises turning on the pump when the capacitive sensor detects a capacitance that corresponds to a high fluid position and de-activating the pump comprises turning off the pump when the speed or torque sensor detects a speed or torque that corresponds to a low fluid position.

20. The method of claim 15 wherein the first sensor is a capacitive sensor and the second sensor is a Hall Effect sensor and activating the pump comprises turning on the pump when the capacitive sensor detects a capacitance that corresponds to a high fluid position and de-activating the pump comprises turning off the pump when the Hall Effect sensor detects a condition that corresponds to a high fluid position.

21. A variable capacitor comprising:
a capacitor body defining a cavity;
a first electrode located within the cavity of the capacitor body;
a second electrode located at least partially external to the capacitor body; and
a dielectric connecting the first and second electrode to form a capacitor having a readable capacitance, the dielectric having a first part made of an insulative material and a second part made of a liquid having a level that changes with respect to the insulative material which causes a change in the capacitance of the capacitor.

22. The variable capacitor of claim 21 wherein at least a portion of the capacitor body forms at least a portion of the insulative material of the dielectric and the second electrode is located completely external to the capacitor body.

23. A capacitive sensor comprising:
a capacitor having a housing and first and second electrodes, the capacitor being at least partially immersed in a liquid having a level that changes in relation to the capacitor and having a variable capacitance depending on the level of the liquid;
a circuit connected to the capacitor to determine the capacitance of the capacitor and thereby determine the level of the liquid; and
wherein the first electrode is located within the capacitor housing and the second electrode is located outside of the capacitor housing and both the first and second electrodes are at least partially immersed in the liquid.

24. The capacitive sensor of claim 23 wherein the second electrode is covered with an insulative material and together the insulative material, at least a portion of the capacitor housing and the liquid form a dielectric between the first and second electrodes and the capacitance of the capacitor changes in a manner corresponding to the level of the liquid.

25. A method of varying capacitance in a variable capacitor comprising:
providing a capacitor having a first electrode, a second electrode and a dielectric connecting the first and second electrodes to form a capacitor having a readable capacitance, the first electrode being located in a housing and the second electrode being spaced apart from the first electrode and housing to form a gap therebetween;
submersing at least a portion of the capacitor in a liquid, creating a liquid level with respect to the capacitor; and
changing the capacitance of the capacitor submersed in the liquid by increasing or decreasing the liquid level.

26. A method of determining a level of liquid comprising:
providing a capacitor at least partially immersed in a liquid having a level that changes in relation to the capacitor, the capacitor having a variable capacitance depending on the level of liquid with a first electrode disposed in a housing and a second electrode positioned outside of the housing containing the first electrode to form a gap therebetween;
using a circuit connected to the capacitor to determine the capacitance of the capacitor; and
determining the level of the liquid based on the capacitance of the capacitor.

27. A method of operating a pump, comprising:
detecting a capacitance for a capacitor at least partially submerged in a liquid having a level that changes in relation to the capacitor, the capacitor having a plurality of capacitances with each capacitance corresponding to a different liquid level and having a first electrode disposed within a housing and a second electrode positioned outside of the housing to form a gap between the housing within which the first electrode is disposed and the second electrode;
activating a pump when a first capacitance is detected;
determining when the pump should be deactivated when a second capacitance is detected; and
deactivating the pump as determined when the second capacitance was detected.

28. A method of detecting fluid level using a capacitive sensor comprising:
providing a capacitive sensor having a housing and first and second electrodes for immersion into a fluid having a level that changes in relation to the electrodes, the fluid forming at least part of a dielectric between the electrodes and together the dielectric and electrodes form a capacitor having a capacitance that varies corresponding to the level of the liquid with respect to the electrodes, wherein the first electrode is electrically connected to a circuit and disposed in the housing and the second electrode being spaced apart from the housing and electrically connected to the circuit via an electrical connection to the circuit;
immersing at least a portion of the first and second electrodes into the fluid such that at least a portion of the electrical connection or second electrode remain above or outside of the liquid to physically separate the electrodes and reduce the risk of minerals collecting between the electrodes and interfering with the operation of the capacitive sensor; and
detecting fluid level by determining or monitoring the capacitance of the capacitor.
